(19) United States
(12) Patent Application Publication
(10) Pub. No.: US 2026/0285659 A1
(43) Pub. Date: Sep. 24, 2026

(54) LIFT DEVICE WITH LATERAL STABILITY SYSTEM

(71) Applicant: Oshkosh Corporation, Oshkosh, WI (US)

(72) Inventors: Muhammad Sannah, Oshkosh, WI (US); Brian Barkley, Oshkosh, WI (US); Ignacy Puszkiewicz, Oshkosh, WI (US); Brian Green, Oshkosh, WI (US)

(73) Assignee: Oshkosh Corporation, Oshkosh, WI (US)

(21) Appl. No.: 19/460,219

(22) Filed: Jan. 26, 2026

Related U.S. Application Data
(60) Provisional application No. 63/749,799, filed on Jan. 27, 2025.

(51) Int. Cl. B66F 9/065; B66F 17/00

(52) U.S. Cl. CPC B66F 9/0655; B66F 17/003

(57) ABSTRACT

A telehandler includes: a chassis; an axle pivotably coupled to the chassis; a tractive element rotatably coupled to the axle; a stability cylinder coupled to the axle and the chassis; a boom assembly coupled to the chassis; an actuator configured to move at least a portion of the boom assembly relative to the chassis; a roll angle sensor coupled to the chassis and configured to provide first sensor data indicating a roll angle of the chassis; a boom angle sensor configured to provide second sensor data indicating a boom angle between the boom assembly and the chassis; and a controller operatively coupled to the roll angle sensor and the boom angle sensor. The controller is configured to control the stability cylinder to limit movement of the axle relative to the chassis based on the first sensor data and the second sensor data.

### CROSS-REFERENCE TO RELATED PATENT APPLICATION

This application claims the benefit of and priority to U.S. Provisional Application No. 63/749,799, filed on Jan. 27, 2025, the entire disclosure of which is hereby incorporated by reference herein.

### BACKGROUND

The present disclosure relates generally to vehicles. More specifically, the present disclosure relates to a stability system for a lift device. Lift devices include a lift assembly, such as a boom, that raises a load above the ground. As the load is raised, the lift device may counteract an overturning moment that acts to tip the lift device. A stability system may increase the resistance of the lift device to the overturning moment.

### SUMMARY

At least one embodiment relates to a telehandler, including: a chassis; an axle pivotably coupled to the chassis; a tractive element rotatably coupled to the axle; a stability cylinder coupled to the axle and the chassis; a boom assembly coupled to the chassis; an actuator configured to move at least a portion of the boom assembly relative to the chassis; a roll angle sensor coupled to the chassis and configured to provide first sensor data indicating a roll angle of the chassis; a boom angle sensor configured to provide second sensor data indicating a boom angle between the boom assembly and the chassis; and a controller operatively coupled to the roll angle sensor and the boom angle sensor. The controller is configured to control the stability cylinder to limit movement of the axle relative to the chassis based on the first sensor data and the second sensor data.

Another embodiment relates to a lift device, including: a chassis; a tractive element coupled to the chassis; a driver coupled to the chassis and configured to drive the tractive element to propel the lift device; a boom assembly coupled to the chassis; an actuator configured to move at least a portion of the boom assembly relative to the chassis; a roll angle sensor coupled to the chassis and configured to provide sensor data indicating a roll angle of the chassis; a boom angle sensor configured to measure a boom angle between the boom assembly and the chassis; and a controller operatively coupled to the roll angle sensor and the boom angle sensor, wherein the controller is configured to: determine whether the roll angle of the chassis exceeds a threshold roll angle; determine whether the boom angle exceeds a threshold boom angle; and in response to a determination that the roll angle of the chassis exceeds the threshold roll angle while the boom angle exceeds the threshold boom angle, at least one of (a) activate an alarm, (b) limit operation of the actuator, or (c) limit operation of the driver.

Another embodiment relates to a telehandler, including: a chassis; an axle pivotably coupled to the chassis; a tractive element rotatably coupled to the axle; a stability cylinder coupled to the axle and the chassis, the stability cylinder having a first chamber and a second chamber; a boom assembly coupled to the chassis; an actuator configured to move at least a portion of the boom assembly relative to the chassis; and a valve assembly fluidly coupled to the first chamber and the second chamber. The valve assembly includes a first valve and a second valve. In an open configuration of the valve assembly, a flow path is defined from the first chamber, through the first valve, through the second valve, and to the second chamber. In a locked configuration of the valve assembly, the first valve fluidly decouples the first chamber from the second chamber, such that the stability cylinder limits movement of the axle relative to the chassis.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front perspective view of a telehandler, according to an exemplary embodiment.

FIG. 2 is a right side view of the telehandler of FIG. 1.

FIG. 3 is a rear perspective view of the telehandler of FIG. 1.

FIG. 4 is a rear perspective view of the telehandler of FIG. 1.

FIG. 5 is a block diagram of a control system of the telehandler of FIG. 1, according to an exemplary embodiment.

FIG. 6 is a schematic top view of a stability map of the telehandler of FIG. 1 in a first configuration, according to an exemplary embodiment.

FIG. 7 is a schematic top view of a stability map of the telehandler of FIG. 1 in a second configuration, according to an exemplary embodiment.

FIG. 8 is a schematic top view of a stability map of the telehandler of FIG. 1 in a third configuration, according to an exemplary embodiment.

FIG. 9 is a schematic top view of a stability map of the telehandler of FIG. 1 in a fourth configuration, according to an exemplary embodiment.

FIG. 10 is a diagram of an operating range of the telehandler of FIG. 1 in an unlocked configuration, according to an exemplary embodiment.

FIG. 11 is a diagram of an operating range of the telehandler of FIG. 1 in a locked configuration, according to an exemplary embodiment.

FIG. 12 is a block diagram of a method of operating a stability system, according to an exemplary embodiment.

FIG. 13 is a schematic of a hydraulic circuit of the telehandler of FIG. 1, according to an exemplary embodiment.

FIG. 14 is a load chart for the telehandler of FIG. 1, according to an exemplary embodiment.

FIG. 15 is a schematic top view of a stability map of the telehandler of FIG. 1 in a fifth configuration, according to an exemplary embodiment.

FIG. 16 is a schematic top view of a stability map of the telehandler of FIG. 1 in a sixth configuration, according to an exemplary embodiment.

FIG. 17 is a schematic top view of a stability map of the telehandler of FIG. 1 in a seventh configuration, according to an exemplary embodiment.

FIG. 18 is a schematic top view of a stability map of the telehandler of FIG. 1 in an eighth configuration, according to an exemplary embodiment.

FIG. 19 is a schematic of a hydraulic circuit of the telehandler of FIG. 1, according to another exemplary embodiment.

FIG. 20 is a schematic of a hydraulic circuit of the telehandler of FIG. 1, according to another exemplary embodiment.

FIG. 21 is a schematic of a hydraulic circuit of the telehandler of FIG. 1, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a telehandler includes a boom assembly that lifts an implement carrying a load. As the boom assembly lifts the load, the overall center of gravity of the telehandler and the load is raised, decreasing the amount of roll of telehandler that is permitted for lateral stability. To improve lateral stability, the telehandler includes (a) a rear axle that is pivotally coupled to the frame assembly and (b) a hydraulic stability cylinder coupled to the rear axle and the frame assembly. The stability cylinder selectively permits oscillation of the rear axle relative to the frame assembly. To increase the lateral stability of the telehandler, the stability cylinder may be locked to fix the rear axle relative to the frame assembly. This configuration improves lateral stability by changing the telehandler from a three-point stability stance to a four-point stability stance.

The telehandler permits three operating modes of the stability cylinder: an open configuration or floating configuration in which the stability cylinder is free to extend and retract; a restricted configuration in which a dampening force opposes movement of the stability cylinder; and a locked configuration in which the stability cylinder is prevented from extending and retracting. The telehandler may switch between the modes of operation based on a boom angle of the boom assembly. When the boom angle is less than or equal to a threshold boom angle (e.g., 40 degrees), a controller may set the stability cylinder to the open configuration, and the rear axle may be free to oscillate. When the boom angle is greater than the threshold boom angle, the controller may set the stability cylinder to either the restricted configuration (e.g., permitting damped oscillation of the rear axle) or the locked configuration (e.g., preventing movement of the rear axle).

The controller may actively monitor one or more conditions indicative of lateral stability (e.g., the roll angle of the frame assembly) to determine if the stability cylinder should be in the restricted configuration or the locked configuration. By actively monitoring the roll angle of the frame assembly, the stability system may automatically execute active control actions (e.g., switching to the locked configuration, reducing engine speed, limiting movement of the boom assembly, etc.) to improve stability when the frame assembly exceeds a threshold roll angle. This configures the stability system as an active stability system, reducing the burden on the operator.

In other telehandlers, switching into the locked configuration requires a manual operator interaction, such as the application of a service brake. Accordingly, such a stability system is considered a manual system. In a manual stability system, the telehandler may not take steps to increase stability without a specific operator interaction. Accordingly, the locked configuration may not meet certain stability requirements (e.g., requirements that are mandated by regulatory standards) that are met by active stability systems.

### Telehandler

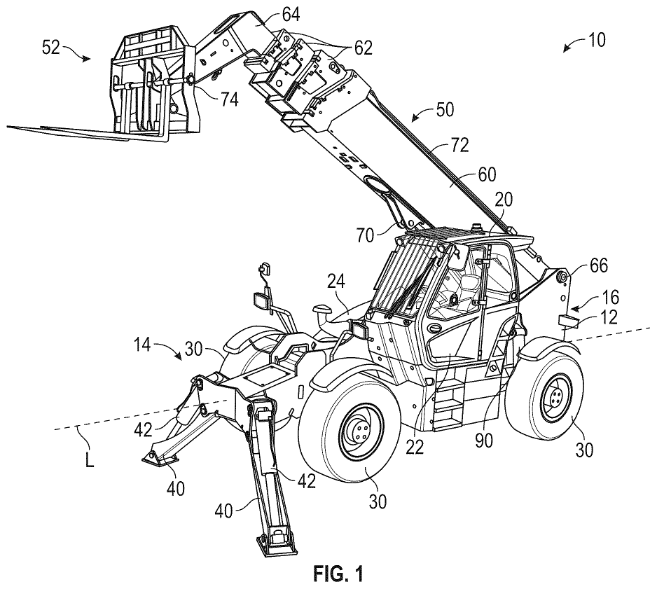

Referring to FIGS. 1-4, a vehicle or work machine (e.g., a lift device) is shown as telehandler 10 according to an exemplary embodiment. In other embodiments, the telehandler 10 is another type of lift device, such as a boom lift, an aerial work platform, a scissor lift, a vertical lift, a compact crawler boom, a forklift, a crane, a bucket truck, or another type of lift device. In yet other embodiments, the telehandler 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, or another type of vehicle or work machine.

As shown in FIGS. 1-4, the telehandler 10 includes a chassis, shown as frame assembly 12, having a front end 14 and a rear end 16. The frame assembly 12 supports an enclosure, shown as cabin 20, that is configured to house an operator of the telehandler 10. The telehandler 10 is supported by a plurality of tractive elements 30 that are rotatably coupled to the frame assembly 12. As shown, the tractive elements 30 include a pair of front wheels (e.g., supported on a front axle) positioned proximate the front end 14 and a pair of rear wheels (e.g., supported on a rear axle) positioned proximate the rear end 16. One or more of the tractive elements 30 may be powered (e.g., driven by the engine 32) to facilitate motion of the telehandler 10 (e.g., propel the telehandler 10 at a travel speed).

The frame assembly 12 defines a longitudinal axis, shown as longitudinal centerline L, that extends along the length of the frame assembly 12. The cabin 20 is laterally offset from the longitudinal centerline L. The cabin 20 includes a door 22 configured to facilitate selective access into the cabin 20. The door 22 may be located on the lateral side of the cabin 20 opposite the boom assembly 50. An enclosure, shown as housing 24, is coupled to the frame assembly 12. The housing 24 is laterally offset from the longitudinal centerline L in a direction opposite the cabin 20. The housing 24 contains various components of the telehandler 10 (e.g., the engine 32, the pump 34, a fuel tank, a hydraulic fluid reservoir, etc.). The housing 24 may include one or more doors to facilitate access to components of the telehandler 10.

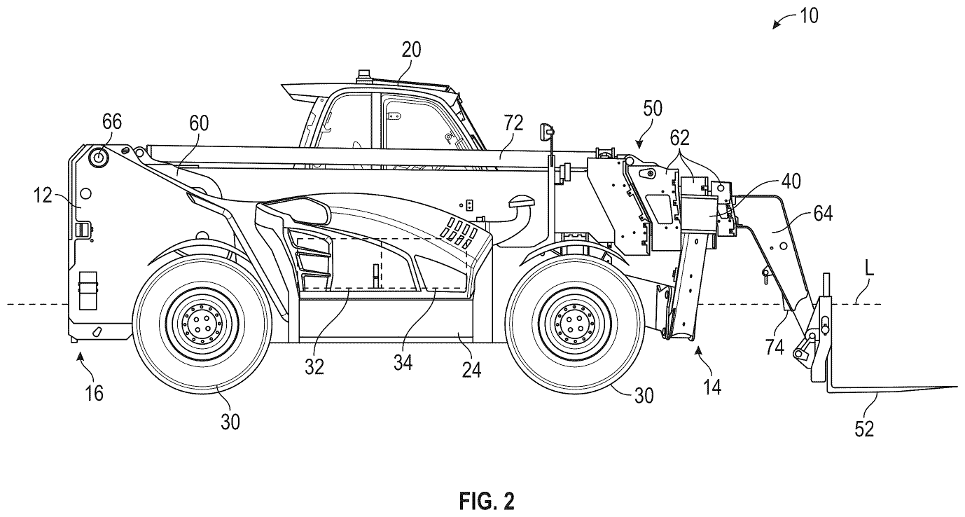

Each of the tractive elements 30 may be powered or unpowered. Referring to FIG. 2, the telehandler 10 includes a powertrain system including a primary driver, shown as engine 32. The engine 32 may receive fuel (e.g., gasoline, diesel, natural gas, etc.) from a fuel tank and combust the fuel to generate mechanical energy. According to an exemplary embodiment, the engine 32 is a compression-ignition internal combustion engine that utilizes diesel fuel. In alternative embodiments, the engine 32 is another type of device (e.g., spark-ignition engine, fuel cell, etc.) that is otherwise powered (e.g., with gasoline, compressed natural gas, hydrogen, etc.). By way of example, the telehandler 10 may include an electric motor in addition to or in place of the engine 32 (e.g., such that the telehandler 10 is configured with an electric drive system or a hybrid drive system).

As shown in FIG. 2, a hydraulic pump, shown as pump 34, receives the mechanical energy from the engine 32 and provides pressurized hydraulic fluid to power the tractive elements 30 and the other hydraulic components of the telehandler 10 (e.g., the outrigger actuators 42, the lift actuator 70, the extension actuator 72, the implement actuator 74, etc.). The pump 34 may provide a pressurized flow of hydraulic fluid to individual motive drivers (e.g., hydraulic motors) configured to facilitate independently driving each of the tractive elements 30 (e.g., in a hydrostatic transmission configuration). In such embodiments, the telehandler 10 also includes other components to facilitate use of a hydraulic system (e.g., reservoirs, accumulators, hydraulic lines, valves, flow control components, etc.). In other embodiments, the engine 32 provides mechanical energy to the tractive elements 30 through another type of transmission. In yet other embodiments, the telehandler 10 includes an energy storage device (e.g., a battery, capacitors, ultra-capacitors, etc.) and/or is electrically coupled to an outside source of electrical energy (e.g., a standard power outlet coupled to the power grid). In some such embodiments, one or more of the tractive elements 30 include an individual motive driver (e.g., a motor that is electrically coupled to the energy storage device, etc.) configured to facilitate independently driving each of tractive elements 30. The outside source of electrical energy may charge the energy storage device or power the motive drivers directly.

Referring to FIG. 1, the telehandler 10 includes a pair of supports, shown as outriggers 40. The outriggers 40 are selectively repositionable between a stored position (e.g., as shown in FIG. 2) and a deployed position (e.g., as shown in FIG. 1). Each outrigger includes a corresponding actuator (e.g., a hydraulic cylinder), shown as outrigger actuator 42, that moves the outriggers 40 between the stored position and the deployed position. As shown, the outriggers 40 are pivotably coupled to the frame assembly 12. In other embodiments, the outriggers 40 are slidably coupled to the frame assembly 12. In the stored position, the outriggers 40 are raised above the ground to facilitate free motion of the telehandler 10. In the deployed position, the outriggers 40 contact the ground, supporting a portion of the weight of the telehandler 10. The outriggers 40 increase the overall size of the footprint of the telehandler 10 that contacts the ground, further increasing the tip resistance (e.g., stability) of the telehandler 10. As shown in FIG. 1, the outriggers 40 are configured to raise the front end 14 off the ground.

The telehandler 10 includes a lift assembly, shown as boom assembly 50, having a proximal end that is pivotably coupled to the frame assembly 12 near the rear end 16. A distal end of the boom assembly 50 supports a tool or manipulator, shown as implement 52. The implement 52 may be any type of mechanism used to support, grab, or otherwise interact with the payload. The implement 52 may include one or more of a carriage and/or set of forks (e.g., pallet forks, bale forks, etc.), a bucket, a grapple or grab (e.g., a bale grab, a log grab, a shear grab, a grab for use in combination with a bucket, etc.), a boom (e.g., a boom supporting a cable used to manipulate roof trusses), an auger, a concrete bucket, and another type of implement.

The telehandler 10 may permit an operator to control the tractive elements 30 and the boom assembly 50 from within the cabin 20 to manipulate (e.g., move, carry, lift, transfer, etc.) a payload (e.g., pallets, building materials, earth, grain, etc.). As shown, the boom assembly 50 is approximately centered on the longitudinal centerline L to facilitate an even weight distribution between the left and the right sides of the telehandler 10. In one embodiment, the longitudinal centerline and a centerline of the boom assembly 50 are disposed within a common plane (e.g., when the boom assembly 50 is stowed, during movement of the boom assembly 50, etc.). In other embodiments, the boom assembly 50 is laterally offset from the longitudinal centerline L.

Referring to FIGS. 1-3, the boom assembly 50 is a telescoping assembly including a series of boom sections that translate relative to one another to vary an overall length of the boom assembly 50. The boom assembly 50 includes a base boom section or base boom 60, one or more middle boom sections or middle booms 62, and a distal boom section or fly boom section shown as fly boom 64. The base boom 60 is pivotally coupled to the frame assembly 12 and pivotable relative to the frame assembly 12 about a lateral axis, shown as axis of rotation 66. The axis of rotation 66 is positioned near the rear end 16. The middle booms 62 are received within the base boom 60 and slidable relative to the base boom 60. In embodiments where the boom assembly 50 includes multiple middle booms 62, the middle booms are slidably received within one another. The fly boom 64 is received within most distal of the middle booms 62 and slidable relative to the middle booms 62.

Referring to FIGS. 1-3, the boom assembly 50 and the implement are articulated by a series of actuators, including a first actuator, shown as lift actuator 70, a second actuator, shown as extension actuator 72, and a third actuator, shown as implement actuator 74. The actuators are configured to control the boom assembly 50 to lift or otherwise manipulate various loads. As shown in FIGS. 1-3, the actuators are hydraulic cylinders powered by pressurized fluid from the pump 34 that extend and retract linearly. In such embodiments, the hydraulic cylinders each include a body that defines an interior volume and receives a shaft. A piston is connected to the shaft and engages an interior surface of the body, dividing the interior volume of the body into a pair of chambers. Pressurized hydraulic fluid is selectively pumped (e.g., by pump 34) into each of the chambers to selectively expand or contract the hydraulic cylinder. The hydraulic cylinders may include bosses, clevises, or other features to facilitate interfacing with other components (e.g., the frame assembly 12, the boom sections, etc.). In other embodiments, the actuators are another type of linear actuator (e.g., electrical, pneumatic, etc.) or are rotary actuators.

The lift actuator 70 is coupled to the frame assembly 12 and the base boom 60. The lift actuator 70 is configured to raise and/or lower the boom assembly 50 by rotating the base boom 60 about the axis of rotation 66. The extension actuator 72 is coupled to the base boom 60 and one of the other boom sections (e.g., the fly boom 64, a middle boom 62, etc.). The extension actuator 72 is configured to vary the length of the boom assembly 50 by causing the middle booms 62 and the fly boom 64 to translate relative to the base boom 60. The implement actuator 74 is coupled to the implement 52 and the fly boom 64. The implement actuator 74 is configured to reposition (e.g., pivot) the implement 52 relative to the fly boom 64.

The telehandler 10 includes an axle assembly, shown as rear axle assembly 80. The rear axle assembly 80 includes a lateral support, shown as rear axle 82, extending laterally across the telehandler 10. A tractive element 30 is rotatably coupled to each end of the rear axle 82. The rear axle 82 is pivotally coupled to the frame assembly 12 such that the rear axle assembly 80 is pivotable relative to the frame assembly 12 about a longitudinal axis (e.g., the longitudinal centerline L). Rotation of the rear axle 82 may permit or facilitate roll of the frame assembly 12.

The telehandler 10 further includes a hydraulic cylinder, linear actuator, or rear axle stability cylinder, shown as stability cylinder 90. The stability cylinder 90 includes a first portion (e.g., a body, a barrel) pivotally coupled to the rear axle 82 and a second portion (e.g., the other of the body or the barrel) pivotally coupled to the frame assembly 12. As the stability cylinder 90 extends, the rear axle assembly 80 rotates in a first direction (e.g., clockwise) relative to the frame assembly 12. As the stability cylinder retracts, the rear axle assembly 80 rotates in a second direction (e.g., counter-clockwise). Accordingly, the rotation of the rear axle assembly 80 may be controlled by controlling the flow of hydraulic fluid into and/or out of the stability cylinder 90.

In an open configuration, the stability cylinder 90 permits free rotation of the rear axle assembly 80 relative to the frame assembly 12. In a restricted configuration, the stability cylinder 90 permits restricted rotation of the rear axle assembly 80 relative to the frame assembly 12 (e.g., the stability cylinder 90 applies a dampening force that opposes movement of the rear axle assembly 80). In a locked configuration, the stability cylinder 90 prevents movement of the rear axle assembly 80 relative to the frame assembly 12. Both the open configuration and the restricted configuration may be considered unlocked configurations, as both configurations permit rotation of the rear axle 82.

### Control System

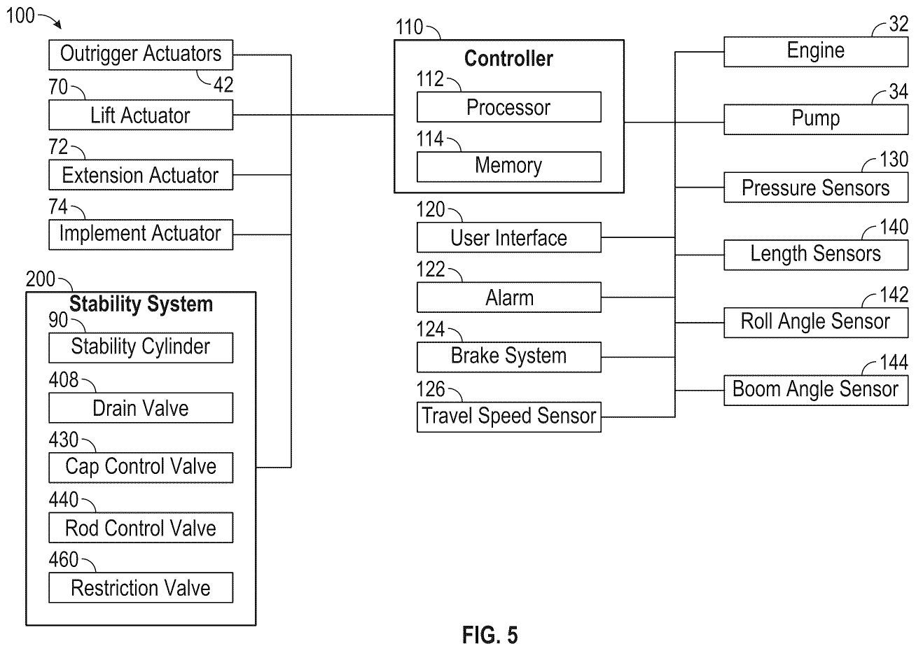

Referring to FIG. 5, the telehandler 10 includes a control system 100 configured to control the operation of the telehandler 10. The control system 100 includes a controller 110 including a processor 112 and a memory 114. The processor 112 may issue commands to and process information from other components. The processor 112 may be implemented as a specific purpose processor, an application specific integrated circuit (ASIC), one or more field programmable gate arrays (FPGAs), a group of processing components, or other suitable electronic processing components. The memory 114 may include one or more devices (e.g., RAM, ROM, flash memory, hard disk storage) for storing data and computer code for completing and facilitating the various user or client processes, layers, and modules described in the present disclosure. The memory 114 may be or include volatile memory or non-volatile memory and may include database components, object code components, script components, or any other type of information structure for supporting the various activities and information structures of the inventive concepts disclosed herein. The memory 114 may be communicably connected to the processor 112 and include computer code or instruction modules for executing one or more processes described herein.

Referring again to FIG. 5, the controller 110 controls the operation of the outrigger actuators 42, the lift actuator 70, the extension actuator 72, the implement actuator 74, the engine 32, and the pump 34. In some embodiments, the pump 34 and/or the engine 32 may be configured to provide power to the actuators, the outriggers 40, the tractive elements 30, and the boom assembly 50. In some embodiments, the controller 110 interfaces with valves that control the flow of hydraulic fluid to the various hydraulically-powered components of the telehandler 10. In some embodiments, the controller 110 controls an operating speed (e.g., a throttle, an engine speed, etc.) of the engine 32.

The control system 100 further includes an input and/or output device or operator interface, shown as user interface 120. The user interface 120 may be configured to provide information to and receive information (e.g., commands) from an operator. By way of example, the user interface 120, may include screens, buttons, switches, joysticks, or other conventional types of interface devices. The user interface 120 may be disposed within the cabin 20. Additionally or alternatively, the user interface 120 may be included as part of a user device (e.g., a smartphone, a table, a laptop computer, a desktop computer, etc.).

The control system 100 further includes a notification system or alarm system, shown as alarm 122, operatively coupled to the controller 110. The alarm 122 is configured to provide a notification or warning to a nearby user (e.g., the operator). The alarm 122 may include an auditory output (e.g., a speaker, a siren, etc.) that provides an audible notification. The alarm 122 may include a visual output (e.g., a screen, a light, etc.) that provides a visual notification.

The telehandler 10 further includes a braking system (e.g., a service brake or parking brake), shown as brake system 124. The brake system 124 may limit (e.g., prevent) movement of the tractive elements 30 to limit (e.g., prevent) movement of the telehandler 10 along the ground. By way of example, the brake system 124 may include a parking brake that is engaged when parking to avoid the telehandler 10 rolling out of the parked position. By way of another example, the brake system 124 may include a service brake that is engaged to slow the telehandler 10 during operation. In some embodiments, the brake system 124 limits the flow of hydraulic fluid into and/or out of hydraulic motors that drive the tractive elements 30. In some embodiments, the brake system 124 engages a friction brake (e.g., a brake pad) to oppose movement of a tractive elements 30. In some embodiments, the controller 110 activates the brake system 124 in response to a user input through the user interface 120.

The control system 100 further includes one or more sensors or transducers, shown as travel speed sensor 126, operatively coupled to the controller 110. The travel speed sensor 126 is configured to provide sensor data indicating a travel speed of the telehandler 10 (e.g., a longitudinal speed at which the telehandler 10 moves along a support surface). The travel speed sensor 126 may include a global positioning system, a rotational speed sensor coupled to a tractive element 30, or another type of sensor.

The control system 100 further includes one or more sensors or pressure transducers, shown as pressure sensors 130, operatively coupled to the controller 110. The pressure sensors 130 may provide sensor data (e.g., pressure data) indicating pressures of one or more fluids within the telehandler 10. By way of example, the pressure sensors 130 may measure pressures of hydraulic fluid at various points within a hydraulic system of the telehandler 10 (e.g., the stability circuit 400).

The control system 100 further includes one or more sensors or transducers, shown as length sensors 140, operatively coupled to the controller 110. The length sensors 140 may provide sensor data indicating a current length of each of the actuators (e.g., the outrigger actuators 42, the lift actuator 70, the extension actuator 72, the implement actuator 74, the stability cylinder 90, etc.). The length sensors 140 may be sensors positioned to sense a length of each actuator directly (e.g., a linear variable differential transformer) or sensors configured to sense other information usable to determine a length of each actuator indirectly (e.g., a rotary potentiometer measuring an angular position of a boom section).

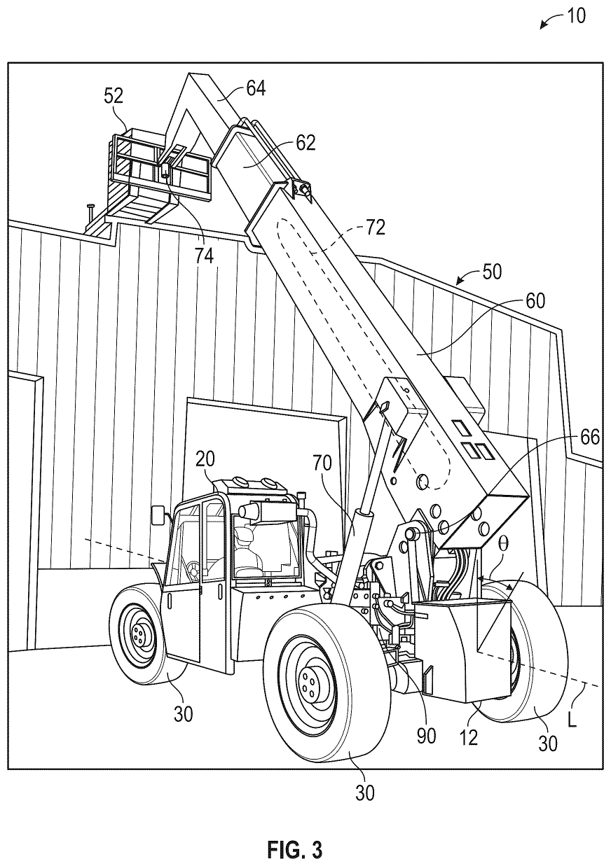

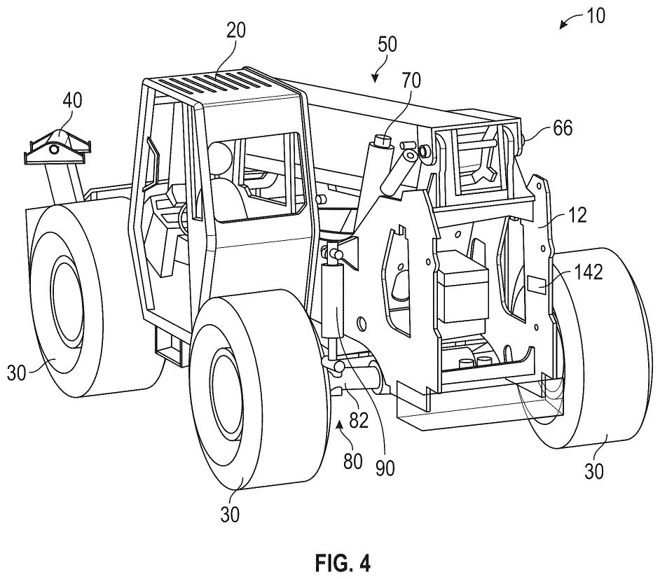

The control system 100 further includes an angle sensor or transducer, shown as roll angle sensor 142, operatively coupled to the controller 110. The roll angle sensor 142 provides sensor data (e.g., orientation data, roll angle data, etc.) indicating a current orientation of the frame assembly 12. In some embodiments, the roll angle sensor 142 indicates a roll angle of the frame assembly 12 (e.g., an orientation of the frame assembly 12 measured about a longitudinal axis, such as the longitudinal centerline L). An example of a roll angle measured about the longitudinal axis L is shown in FIG. 3 as roll angle Θ, measured between (a) a vertical line indicating the direction of gravity and (b) a portion of the frame assembly 12 that is vertical when the telehandler 10 is level. The roll angle sensor 142 may include an inertial measurement unit, a gyroscopic sensor, or another type of sensor. As shown in FIG. 4, the roll angle sensor 142 is coupled to the frame assembly 12.

Referring again to FIG. 5, the control system 100 includes an angle sensor or transducer, shown as boom angle sensor 144, operatively coupled to the controller 110. The boom angle sensor 144 provides sensor data (e.g., boom angle data) indicating an angle of incline of the boom assembly 50 (e.g., as controlled by the lift actuator 70). A boom angle of 0 degrees may be the lowest position of the boom assembly 50, and the boom angle may increase as the boom assembly 50 rotates upward. The boom angle sensor 144 may include an inertial measurement unit, a gyroscopic sensor, a potentiometer, and/or another type of sensor.

### Stability System

Referring to FIGS. 4 and 5, the telehandler 10 includes a rear axle stability system, active stability system, lateral stability system, or active lateral stability system, shown as stability system 200. The stability system 200 may enhance, improve, or otherwise facilitate a stability (e.g., tip resistance) of the telehandler 10 through control over various systems of the telehandler 10. In some embodiments, the stability system 200 facilitates a lateral stability of the telehandler 10.

As used herein, the lateral stability of the telehandler 10 may refer to the resistance of the telehandler 10 to an overturning moment with respect to various tip lines. A tip line may represent a boundary of a range of stable locations for the telehandler 10. When the overall center of gravity of the telehandler 10 (i.e., a center of gravity of the telehandler 10 and any payload supported by the telehandler 10) remains within the range of stable positions, the telehandler 10 remains stable. If the overall center of gravity of the telehandler 10 extends beyond one of the tip lines, the force of gravity may result in an overturning moment driving rotation of the telehandler 10 about the corresponding tip line. The lateral stability of the telehandler 10 may specifically refer to the tip lines along the left and right sides of the range of stable locations.

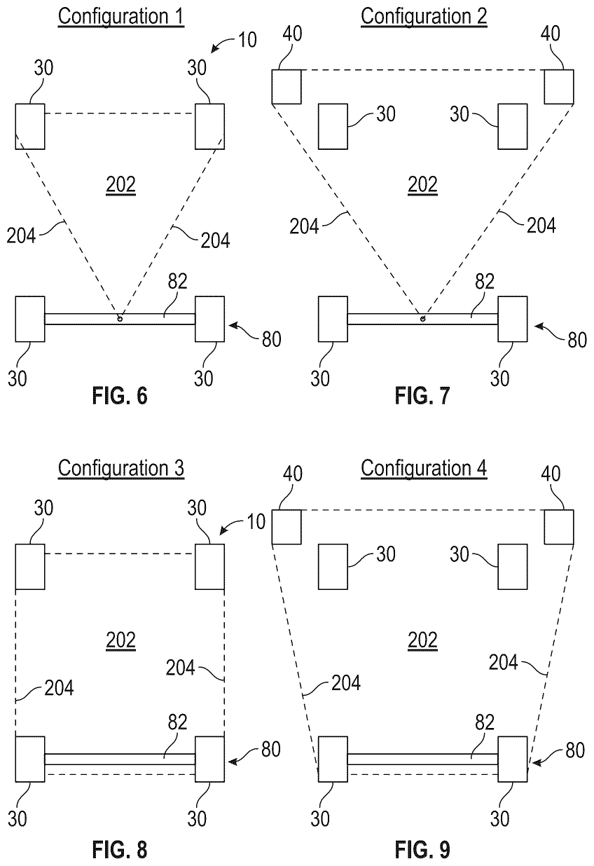

Referring to FIGS. 6-9, the telehandler 10 may perform various actions to vary a range of stable locations 202 and increase the stability of the telehandler 10. In a first configuration shown in FIG. 6, the outriggers 40 are retracted (e.g., not deployed) and the stability cylinder 90 is in an unlocked configuration (e.g., the open configuration or the restricted configuration), permitting rotation of the rear axle assembly 80. In the first configuration, (a) a first tip line 204 extends between the left front wheel and the axis of rotation of the rear axle assembly 80 and (b) a second tip line 204 extends between the right front wheel and the axis of rotation of the rear axle assembly 80. The first configuration is a three-point stability stance, as both of the tip lines 204 intersect at the axis of rotation of the rear axle assembly 80.

In a second configuration shown in FIG. 7, the outriggers 40 are deployed and the stability cylinder 90 is in an unlocked configuration, permitting rotation of the rear axle assembly 80. In the second configuration, (a) a first tip line 204 extends between the left outrigger 40 and the axis of rotation of the rear axle assembly 80 and (b) a second tip line 204 extends between the right outrigger 40 and the axis of rotation of the rear axle assembly 80. The second configuration is a three-point stability stance, as both of the tip lines 204 intersect at the axis of rotation of the rear axle assembly 80. The second configuration may have a larger range of stable locations 202 than the first configuration, and thus may be more stable.

In a third configuration shown in FIG. 8, the outriggers 40 are retracted (e.g., not deployed) and the stability cylinder 90 is in the locked configuration, preventing rotation of the rear axle assembly 80. In the third configuration, (a) a first tip line 204 extends between the left front wheel and the left wheel of the rear axle assembly 80 and (b) a second tip line 204 extends between the right front wheel and the right wheel of the rear axle assembly 80. The third configuration is a four-point stability stance, as the rear ends of the tip lines 204 are offset from one another. The third configuration may have a larger range of stable locations 202 than the first configuration, and thus may be more stable.

In a fourth configuration shown in FIG. 9, the outriggers 40 are deployed and the stability cylinder 90 is in the locked configuration, preventing rotation of the rear axle assembly 80. In the fourth configuration, (a) a first tip line 204 extends between the left outrigger 40 and the left wheel of the rear axle assembly 80 and (b) a second tip line 204 extends between the right outrigger 40 and the right wheel of the rear axle assembly 80. The fourth configuration is a four-point stability stance, as the rear ends of the tip lines 204 are offset from one another. The fourth configuration may have a larger range of stable locations 202 than the first configuration, the second configuration, and the third configuration, and thus may be the most stable configuration.

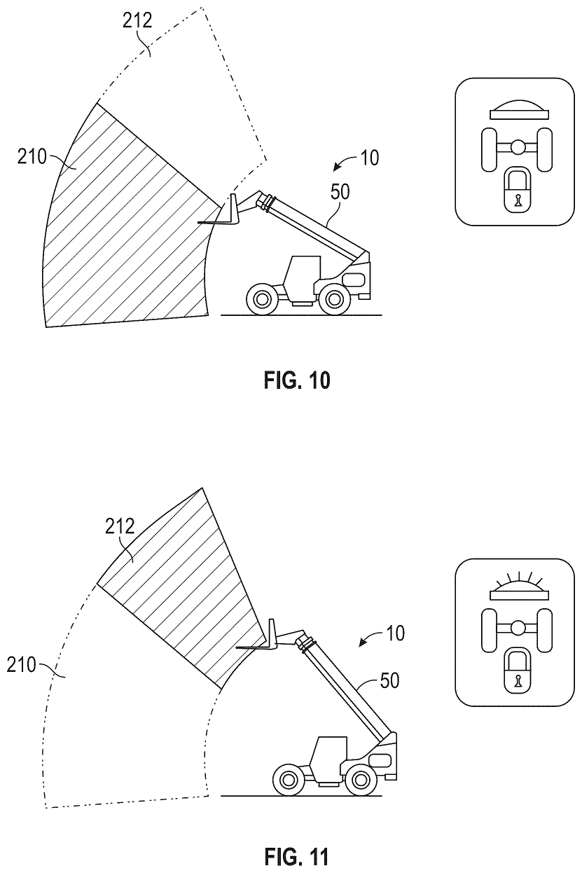

As shown in the examples of FIGS. 6-9, changing the stability cylinder 90 to the locked configuration greatly increases the lateral stability of the telehandler 10. FIG. 10 illustrates an operating range of the telehandler 10 with the stability cylinder 90 permitting the rear axle 82 to oscillate (e.g., in the open configuration or the restricted configuration). FIG. 11 illustrates an operating range of the telehandler 10 with the stability cylinder 90 in the locked configuration. FIGS. 10 and 11 show a lower range of positions 210 and an upper range of positions 212. The boundary between the lower range of positions 210 and the upper range of positions 212 may represent a threshold boom angle. With the stability cylinder 90 permitting the rear axle 82 to oscillate, the boom assembly 50 is able to operate in the lower range of positions 210 while remaining stable. With the stability cylinder 90 in the locked configuration, the boom assembly 50 is able to operate in both the lower range of positions 210 and the upper range of positions 212 while remaining stable. Accordingly, FIGS. 10 and 11 illustrate the increase in capability provided by the stability cylinder 90.

### Stability Control Method

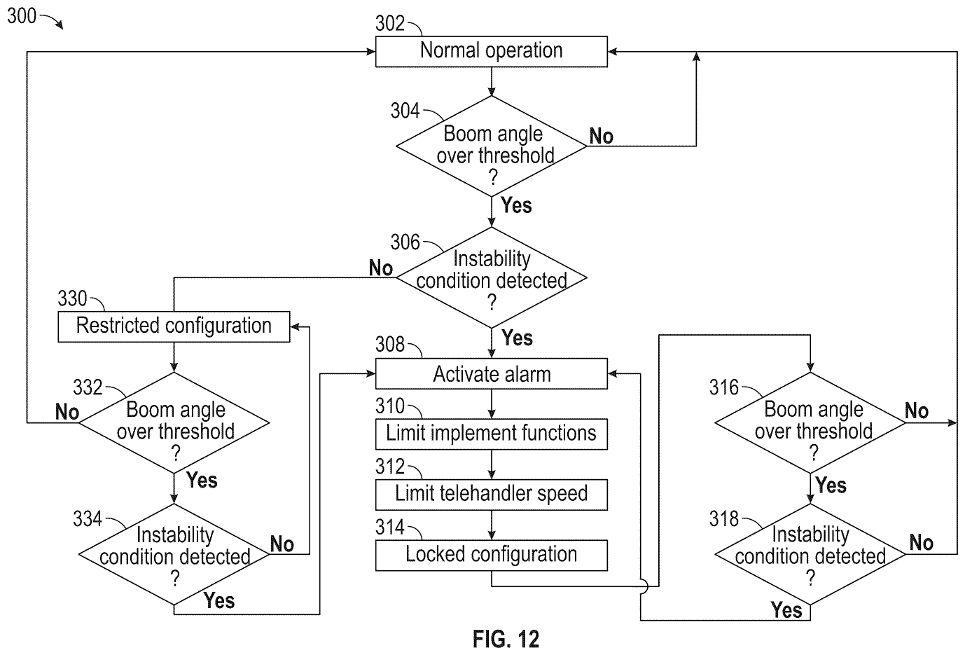

Referring to FIG. 12, a method of operating the stability system 200 is shown as method 300, according to an exemplary embodiment. The stability system 200 may perform the method 300 utilizing the control system 100. Throughout the method 300, the control system 100 may actively monitor the telehandler 10 and automatically perform one or more stability actions to increase the stability of the telehandler 10. The control system 100 may perform the one or more stability actions in response to certain predetermined measured conditions within the telehandler 10. The one or more stability actions may or may not require use of the stability cylinder 90.

In step 302 of the method 300, the telehandler 10 performs unrestricted or normal operation (e.g., operates normally). During normal operation, the telehandler 10 performs one or more functions without restriction. By way of example, during normal operation, the stability cylinder may be in the open configuration. By way of another example, during normal operation, the stability system 200 may permit both (a) implement functions that improve stability (e.g., lowering the boom assembly 50, retracting the boom assembly 50, deploying the outriggers 40, etc.) and (b) implement functions that decrease stability (e.g., raising the boom assembly 50, extending the boom assembly 50, retracting the outriggers 40, etc.). By way of another example, during normal operation, the alarm 122 may be deactivated. By way of another example, during normal operation, the stability system 200 may permit the engine 32 to operate throughout a normal operating range of engine speeds.

In step 304 of the method 300, the stability system 200 determines if a boom angle of the boom assembly 50 is over a threshold angle. The controller 110 may use sensor data from the boom angle sensor 144 to determine the current boom angle of the boom assembly 50. The controller 110 may compare the current boom angle to a threshold boom angle. The threshold boom angle may be predetermined and stored in the memory 114. In some embodiments, the threshold boom angle is fixed. In some embodiments, the threshold boom angle is 40 degrees. The threshold boom angle may represent an angle of incline of the boom assembly 50 that, when exceeded, results in a reduced stability of the telehandler 10.

If the controller 110 determines “no” in step 304, the current boom angle is less than or equal to the threshold boom angle, and the method 300 returns to step 302. Accordingly, the telehandler 10 remains in normal operation, and step 304 is repeated. If the controller 110 determines “yes” in step 304, the current boom angle is greater than the threshold boom angle, and the method 300 proceeds to step 306.

In step 306 of the method 300, the stability system 200 determines if an instability condition of the telehandler 10 is detected. The instability condition may specifically be related to the lateral stability of the telehandler 10. The controller 110 may utilize the roll angle sensor 142 to determine a current roll angle of the frame assembly 12. The controller 110 may compare the current roll angle to a threshold roll angle associated with lateral instability. The controller 110 may determine that an instability condition of the telehandler 10 is detected in response to a determination that the magnitude of the current roll angle is greater than or equal to the threshold roll angle. In other words, exceeding the threshold roll angle in either direction (i.e., clockwise or counter-clockwise) may be identified as an instability condition. In some embodiments, the threshold roll angle is predetermined and stored in the memory 114. In some embodiments, the threshold roll angle is between 2.5 degrees and 4 degrees. In some embodiments, the threshold roll angle is selected based on a size of the telehandler 10. By way of example, the threshold roll angle may increase for larger telehandlers 10. A relationship between threshold roll angle and machine size (e.g., height, weight, length, reach, etc.) may be predetermined and stored in the memory 114.

If the controller 110 determines “yes” in step 306, an instability condition is detected, and the method 300 proceeds to step 308. In step 308 of the method 300, the alarm 122 is activated. When activated, the alarm 122 provides a visual and/or audible notification or warning of the instability condition to an operator. The operator may then vary their control over the telehandler 10 accordingly. By way of example, the alarm 122 may signal to the operator that they should perform one or more actions to increase the stability of the telehandler 10, such as slowing the speed of the telehandler 10 or lowering the boom assembly 50.

In step 310 of the method 300, the controller 110 may limit one or more implement functions of the telehandler 10. The implement functions may include functions other than driving the tractive elements 30 to propel the telehandler 10. By way of example, the implement functions may include functions performed by the boom assembly 50, the implement 52, and/or the outriggers 40. Step 310 of the method 300 may encourage actions that increase the stability of the telehandler 10 and discourage functions that would decrease the stability of the telehandler 10.

In step 310, the controller 110 may limit one or more implement functions that would decrease the stability of the telehandler 10. If such implement functions are not already being performed, the controller 110 may prevent the implement functions from being initiated. If such implement functions are being performed when step 310 is started, the controller 110 may gradually bring the functions to a controlled stop (e.g., by reducing the speed of the corresponding actuator). By way of example, the controller 110 may limit lifting of the boom assembly 50 by the lift actuator 70. By way of another example, the controller 110 may limit extension of the boom assembly 50 by the extension actuator 72. By way of another example, the controller 110 may limit retraction of the outriggers 40 by the outrigger actuators 42.

In step 310, the controller 110 may permit one or more implement functions that would increase the stability of the telehandler 10. By way of example, the controller 110 may permit lowering of the boom assembly 50 by the lift actuator 70. By way of another example, the controller 110 may permit retraction of the boom assembly 50 by the extension actuator 72. By way of another example, the controller 110 may permit deployment of the outriggers 40 by the outrigger actuators 42. Accordingly, the controller may limit (e.g., prevent) movement of an actuator in a first direction that would decrease stability of the telehandler 10 while permitting movement of the actuator in a second direction that would increase stability of the telehandler.

In step 312 of the method 300, a speed of the telehandler 10 is limited. In some embodiments, the speed that is limited includes a travel speed at which the telehandler 10 is propelled by the tractive elements 30 (e.g., while being driven by the engine 32). In some embodiments, the speed that is limited includes a speed of the boom assembly 50, the outriggers 40, or another component of the telehandler 10.

In some embodiments, in step 312, the travel speed of the telehandler 10 is limited. Advantageously, limiting the speed of the telehandler 10 may increase the stability of the telehandler 10. By way of example, the controller 110 may limit the travel speed to at or below a maximum travel speed (e.g., a speed limit). By way of another example, the controller 110 may prevent propulsion of the telehandler 10 entirely (e.g., limit the speed to zero speed). The controller 110 may limit the travel speed directly. By way of example, the controller 110 may monitor the travel speed using the travel speed sensor 126 and limit the power applied to the tractive elements 30 (e.g., by controlling a speed of the engine 32 or an electric motor used to drive the tractive elements 30, by controlling a transmission that couples the engine 32 to the tractive elements 30, etc.). By way of another example, the controller 110 may control the brake system 124 to limit the travel speed.

In some embodiments, in step 312, an engine speed of the engine 32 is reduced or otherwise limited. The engine speed of the engine 32 (e.g., measured in revolutions per minute (RPM)) may represent a speed at which the telehandler 10 is capable of performing various functions. By way of example, the telehandler 10 may be capable of a greater travel speed along the ground at higher engine speeds. By way of another example, reducing the engine speed may reduce the flow rate of the pump 34, which in turn limits the speeds of the various hydraulic actuators of the telehandler 10.

In step 312, the controller 110 may reduce engine speed from a normal operating range to a reduced operating range (e.g., a limp home range). By way of example, the normal operating range may extend from 1000 RPM to 4000 RPM, and the controller 110 may reduce the engine speed to a maximum of 2000 RPM. By reducing the engine speed, the stability system 200 reduces acceleration and maximum operating speed of the telehandler 10 (e.g., travel speed, movement speed of the boom assembly 50, etc.). Accordingly, the reduction in engine speed limits movements that may otherwise negatively affect stability.

In step 314, the controller 110 places the stability cylinder 90 into the locked configuration. In the locked configuration, a length of the stability cylinder 90 is fixed, such that the orientation of the rear axle assembly 80 relative to the frame assembly 12 is fixed. As discussed with respect to FIGS. 6-11, the locked configuration of the stability cylinder 90 increases the stability of the telehandler 10. The controller 110 may configure the stability cylinder 90 into the locked configuration by preventing the flow of fluid into and/or out of the stability cylinder 90 (e.g., by controlling one or more valves).

In step 316 of the method 300, the stability system 200 determines if the boom angle of the boom assembly 50 is over a threshold angle. This determination may be similar to the determination of step 304. If the controller 110 determines “no” in step 316, the current boom angle is less than or equal to the threshold boom angle, and the method 300 returns to step 302. This indicates that the boom assembly 50 has been lowered below the threshold boom angle. Accordingly, the telehandler 10 returns to normal operation, and step 304 is repeated. If the controller 110 determines “yes” in step 316, the current boom angle remains greater than the threshold boom angle, and the method 300 proceeds to step 318.

In step 318 of the method 300, the stability system 200 determines if the instability condition of the telehandler 10 is detected. This determination may be similar to the determination of step 306. If the controller 110 determines “no” in step 318, the instability condition is no longer detected, indicating that the telehandler 10 is now stable enough for normal operation. The method 300 returns to the telehandler 10 to normal operation in step 302, and step 304 may then be repeated. If the controller 110 determines “yes” in step 318, the instability condition continues to be detected, and the method 300 returns to step 308. Accordingly, the stability actions of steps 308, 310, 312, and 314 continue to be performed until the boom angle falls below the threshold boom angle and/or the instability condition is no longer detected.

If the controller 110 determines “no” in step 306, the method proceeds to step 330. In this situation, the boom assembly 50 has been lifted above the threshold boom angle, but an instability condition has not been detected. In step 330, the controller 110 places the stability cylinder 90 into the restricted configuration. In the restricted configuration, a length of the stability cylinder 90 is variable, such that the rear axle assembly 80 is permitted to oscillate relative to the frame assembly 12. However, fluid flowing into and/or out of the stability cylinder 90 may be forced through an orifice to produce a damping force that opposes movement of the stability cylinder 90. This increases the stability of the telehandler 10 relative to the open configuration, but still permits adjustment the rear axle assembly 80 (e.g., when passing over uneven terrain).

In step 332 of the method 300, the stability system 200 determines if the boom angle of the boom assembly 50 is over the threshold angle. This determination may be similar to the determination of step 304. If the controller 110 determines “no” in step 332, the current boom angle is less than or equal to the threshold boom angle, and the method 300 returns to step 302. This indicates that the boom assembly 50 has been lowered below the threshold boom angle. Accordingly, the telehandler 10 returns to normal operation, and step 304 is repeated. If the controller 110 determines “yes” in step 332, the current boom angle remains greater than the threshold boom angle, and the method 300 proceeds to step 334.

In step 334 of the method 300, the stability system 200 determines if the instability condition of the telehandler 10 is detected. This determination may be similar to the determination of step 306 and step 318. If the controller 110 determines “no” in step 334, the instability condition is no longer detected, and the method 300 returns to step 330, such that the telehandler 10 remains in the restricted configuration. If the controller 110 determines “yes” in step 334, the instability condition is detected, and the method 300 returns to step 308. Accordingly, the stability actions of steps 308, 310, 312, and 314 may be performed until the boom angle falls below the threshold boom angle and/or the instability condition is no longer detected.

As shown in FIG. 12, the method 300 includes various strategies to automatically increase the stability of the telehandler 10. In other embodiments, one or more steps of the method 300 are omitted. By way of example, one or more of the steps 308, 310, 312, and 314 may be omitted (e.g., based on the capabilities of the telehandler 10). The remaining steps of the method 300 may still increase the stability of the telehandler 10.

In some embodiments, the stability cylinder 90 is not utilized by the method 300. By way of example, the telehandler 10 may omit the stability cylinder 90, and the rear axle assembly 80 may be fixed to the frame assembly 12, free to oscillate relative to the frame assembly 12, or pivotable relative to the frame assembly 12 and biased into a central position by one or more springs. By way of another example, the telehandler 10 may include the stability cylinder 90 without utilizing the stability cylinder 90 in the method 300. Such a method may be utilized to improve the stability of a telehandler 10 that was manufactured without a stability cylinder 90, or a telehandler 10 where operation of a stability cylinder 90 cannot be easily controlled. By way of example, the method 300 may be retrofitted onto a telehandler 10 that was manufactured without a stability cylinder 90.

In embodiments where the stability cylinder 90 is not utilized, steps 314, 330, 332, and 334 may be omitted from the method 300. If the controller 110 determines “no” in step 306 because an instability condition is not detected, the method 300 may return to step 302 and maintain normal operation of the telehandler 10. In such an embodiment, normal operation may not specify a configuration of a stability cylinder 90. Additionally, the method 300 may proceed directly from reducing engine speed in step 312 to step 316. Beneficially, the method 300 may operate the alarm 122, the boom assembly 50, the outriggers 40, and the engine 32 to improve the stability of the telehandler 10 without the use of the stability cylinder 90.

In some embodiments, the stability cylinder 90 is not reconfigurable into a restricted configuration. By way of example, a telehandler 10 may not include the valving necessary to apply the damping force onto the stability cylinder 90. Accordingly, the stability cylinder 90 may be operable in only the open configuration and the locked configuration. In embodiments where the stability cylinder 90 is not reconfigurable into the restricted configuration, steps 330, 332, and 334 may be omitted from the method 300. If the controller 110 determines “no” in step 306 because an instability condition is not detected, the method 300 may return to step 302 and maintain normal operation of the telehandler 10 with the stability cylinder 90 in the open configuration.

In some embodiments, one or more stability control actions are performed in response to a manual input from an operator. By way of example, steps 308, 310, 312, and/or 314 may be performed in response to a manual input. The manual input may be provided through the user interface 120. The manual input may include an activation of the brake system 124 (e.g., the service brakes and/or the parking brake). By way of another example, the manual input may include switching off the engine 32 (e.g., by turning off an ignition, such as a key, of the user interface 120). By way of another example, the manual input may include a gear select (e.g., a neutral gear indicating that the telehandler 10 is not under powered travel) made through the user interface 120.

In some embodiments, the stability system 200 limits a travel speed of the telehandler 10 based on a position of the boom assembly 50. By way of example, the controller 110 may limit a travel speed to at or below a maximum travel speed (e.g., a speed limit) when the boom angle is above the threshold boom angle. If the boom angle is reduced below the threshold boom angle, the controller 110 may remove the maximum travel speed limitation.

### Hydraulic Arrangement

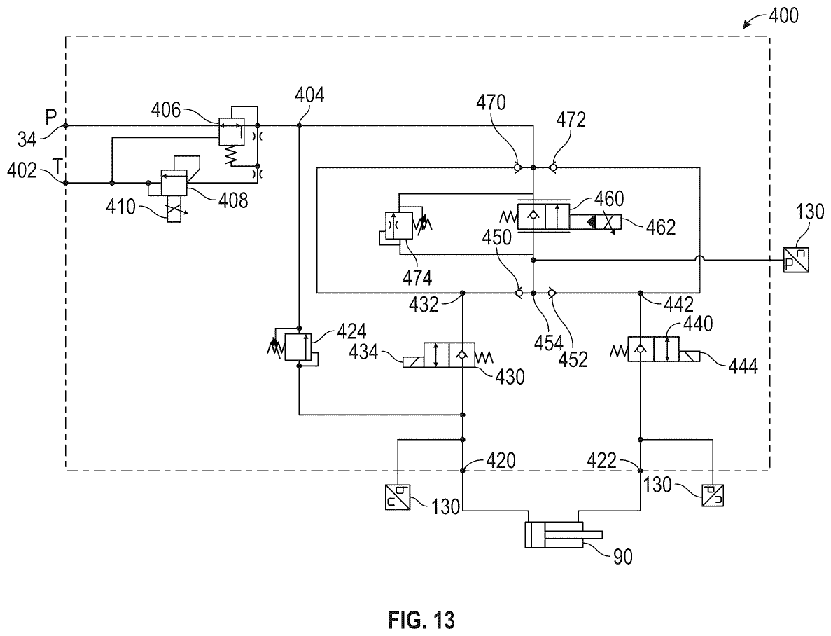

Referring to FIG. 13, the stability system 200 includes a hydraulic circuit, hydraulic arrangement, hydraulic system, or valve assembly, shown as stability circuit 400. The stability circuit 400 controls operation of the stability cylinder 90, according to an exemplary embodiment. The stability circuit 400 may be reconfigurable between the open configuration, the restricted configuration, and the locked configuration by the controller 110.

As shown in FIG. 13, the stability circuit 400 receives pressurized hydraulic fluid from the pump 34. The stability circuit 400 is fluidly coupled to a low-pressure return, shown as tank 402. The pump 34 supplies pressurized hydraulic fluid to a location in the stability circuit 400, shown as pressure supply node 404.

The pressurized hydraulic fluid is supplied from the pump 34 to the pressure supply node 404 through a pilot operated, pressure reducing/relieving valve, shown as supply valve 406. The supply valve is fluidly coupled to the pump 34, the tank 402, and the pressure supply node 404. The supply valve 406 may proportionally transition between (a) supplying pressurized fluid from the pump 34 to the pressure supply node 404 and (b) draining pressurized fluid from the pressure supply node 404 to tank 402. The supply valve 406 may be arranged such that as the pressure at the pressure supply node 404 decreases, the supply valve 406 provides fluid from the pump 34 to the pressure supply node 404. As the pressure at the pressure supply node 404 increases, the supply valve 406 drains fluid from the pressure supply node 404 to the tank 402. Accordingly, the supply valve 406 maintains the pressure at the pressure supply node 404 at a desired pressure or within a desired range of pressures throughout operation.

The stability circuit 400 further includes a proportional solenoid pressure relief valve, shown as drain valve 408. The drain valve 408 is fluidly coupled to the tank 402 and fluidly coupled to the pressure supply node 404 through a pair of orifices. The drain valve 408 is biased toward a closed configuration by a proportional solenoid, shown as drain solenoid 410. The drain solenoid 410 is operatively coupled to the controller 110 to permit control over the drain solenoid 410. The drain valve 408 is biased toward a closed position by the pressure upstream of the drain valve 408 (e.g., the pressure of the pressure supply node 404 after flowing through the two orifices). When the drain solenoid 410 is energized, the drain valve 408 remains in the closed position until the upstream pressure overcomes the force of the drain solenoid 410 (e.g., due to a spike in pressure at the pressure supply node 404). If the drain solenoid 410 is overcome, the drain valve 408 opens to permit fluid to flow to the tank 402. The energization level (e.g., supplied voltage or current) of the drain solenoid 410 may be varied by the controller 110 to vary the pressure at which the drain valve 408 opens. When the drain solenoid 410 is deenergized, the drain valve 408 may open to drain the stability circuit 400 (e.g., when not in use, during maintenance, etc.).

The stability circuit 400 further includes a pair of inlets/outlets or ports, shown as cap end port 420 and rod end port 422. The cap end port 420 is fluidly coupled to a first chamber (e.g., a cap end) of the stability cylinder 90. The rod end port 422 is fluidly coupled to a second chamber (e.g., a rod end) of the stability cylinder 90. As the stability cylinder 90 extends, fluid enters the stability circuit 400 from the stability cylinder 90 through the rod end port 422, and fluid exits the stability circuit 400 into the stability cylinder 90 through the cap end port 420. As the stability cylinder 90 retracts, fluid enters the stability circuit 400 from the stability cylinder 90 through the cap end port 420, and fluid exits the stability circuit 400 into the stability cylinder 90 through the rod end port 422. In some embodiments, all fluid entering or exiting the stability cylinder 90 passes through the rod end port 422 and/or the cap end port 420.

A first directional control valve, shown as cap control valve 430, is fluidly coupled between the cap end port 420 and a location, shown as node 432. The cap control valve 430 is repositionable between an open position and a closed position. In the open position, the cap control valve 430 permits fluid to flow freely between the cap end port 420 and the node 432. In the closed position, the cap control valve 430 (a) prevents flow from the cap end port 420 to the node 432 and (b) permits flow from the node 432 to the cap end port 420. The cap control valve 430 may include a flow control element, such as a check valve, that facilitates the single direction flow while in the closed position.

The cap control valve 430 includes a solenoid, shown as cap solenoid 434. The cap solenoid 434 is operatively coupled to the controller 110 and controlled by the controller 110. The cap control valve 430 is biased into the closed position by a spring. When energized, the cap control valve 430 overcomes the biasing force of the spring to move the cap control valve 430 to the open position.

A second directional control valve, shown as rod control valve 440, is fluidly coupled between the rod end port 422 and a location, shown as node 442. The rod control valve 440 is repositionable between an open position and a closed position. In the open position, the rod control valve 440 permits fluid to flow freely between the rod end port 422 and the node 442. In the closed position, the rod control valve 440 (a) prevents flow from the rod end port 422 to the node 442 and (b) permits flow from the node 442 to the rod end port 422. The rod control valve 440 may include a flow control element, such as a check valve, that facilitates the single direction flow while in the closed position.

The rod control valve 440 includes a solenoid, shown as rod solenoid 444. The rod solenoid 444 is operatively coupled to the controller 110 and controlled by the controller 110. The rod control valve 440 is biased into the closed position by a spring. When energized, the rod control valve 440 overcomes the biasing force of the spring to move the rod control valve 440 to the open position.

A pair of flow control elements, shown as check valve 450 and check valve 452, are fluidly coupled to a location, shown as node 454. Specifically, the check valve 450 is fluidly coupled between the node 432 and the node 454. The check valve 450 permits fluid flow from the node 432 toward the node 454 and prevents fluid flow from the node 454 toward the node 432. The check valve 452 is fluidly coupled between the node 442 and the node 454. The check valve 452 permits fluid flow from the node 442 toward the node 454 and prevents fluid flow from the node 454 toward the node 442.

A third directional control valve or proportional directional control valve, shown as restriction valve 460, is fluidly coupled between the pressure supply node 404 and the node 454. The restriction valve 460 is continuously repositionable between an open position and a closed position. In the open position, the restriction valve 460 permits fluid to flow freely between the pressure supply node 404 and the node 454. In the closed position, the restriction valve 460 (a) prevents flow from the node 454 to the pressure supply node 404 and (b) permits flow from the pressure supply node 404 to the node 454. The restriction valve 460 may include a flow control element, such as a check valve, that facilitates the single direction flow while in the closed position.

The restriction valve 460 includes a solenoid, shown as restriction solenoid 462. The restriction solenoid 462 is operatively coupled to the controller 110 and controlled by the controller 110. The restriction valve 460 is biased into the closed position by a spring. When energized, the restriction solenoid 462 overcomes the biasing force of the spring to move the restriction valve 460 toward the open position. The force of the restriction solenoid 462 may be varied by varying a signal from the controller 110 to partially open or partially close the restriction valve 460. As the force of the restriction solenoid 462 decreases and the restriction valve 460 closes, the restriction valve 460 acts as an orifice to resist the flow of fluid (e.g., restricted flow) from the node 454 toward the pressure supply node 404.

A pair of flow control elements, shown as check valve 470 and check valve 472, are fluidly coupled to the pressure supply node 404. Specifically, the check valve 470 is fluidly coupled between the pressure supply node 404 and the node 432. The check valve 470 permits fluid flow from the pressure supply node 404 toward the node 432 and prevents fluid flow from the node 432 toward the pressure supply node 404. The check valve 472 is fluidly coupled between the pressure supply node 404 and the node 442. The check valve 472 permits fluid flow from the pressure supply node 404 toward the node 442 and prevents fluid flow from the node 442 toward the pressure supply node 404.

A pressure relief valve, shown as relief valve 474, is fluidly coupled to the node 454 and the pressure supply node 404. Accordingly, the relief valve 474 is connected in parallel with the restriction valve 460. The relief valve 474 is biased into a closed position in which the relief valve 474 fluidly decouples the node 454 from the pressure supply node 404. In response to the pressure at the node 454 exceeding a threshold pressure, the relief valve 474 opens to permit fluid to flow to the pressure supply node 404, bypassing the restriction valve 460. Accordingly, if the pressure at the node 454 exceeds a threshold pressure while the restriction valve 460 is partially or fully closed, the relief valve 474 permits the fluid to bypass the restriction valve 460 (e.g., to prevent damage to the stability circuit 400). By way of example, the relief valve 474 may be activated when an abnormally large force is experienced by the rear axle 82, permitting the rear axle 82 to rotate relative to the frame assembly 12 and preventing damage to the frame assembly 12, the stability cylinder 90, and components of the stability circuit 400.

As shown in FIG. 13, the stability circuit 400 includes a series of pressure sensors 130 operatively coupled to the controller 110. A first pressure sensor 130 is fluidly coupled to the node 454 and measures a pressure of the fluid at the node 454. A second pressure sensor 130 is fluidly coupled to the cap end port 420 and measures a pressure of the fluid in the cap end of the stability cylinder 90. A third pressure sensor 130 is fluidly coupled to the rod end port 422 and measures a pressure of the fluid in the rod end of the stability cylinder 90. The pressure sensors 130 may provide diagnostic information that the controller 110 may utilize to determine an operational status of the stability circuit 400. By way of example, by monitoring the signals from the pressure sensors 130, the controller 110 may identify discrepancies from expected values and identify changes in health of the stability circuit 400. In one such example, the pressure sensors 130 may indicate that a particular area of the stability circuit 400 is not performing as expected, and the user interface 120 may instruct an operator to evaluate the health of components impacting that area of the stability circuit 400. The controller 110 may control the stability circuit 400 to perform periodic health checks (e.g., every 30 hours of vehicle operation) using the pressure sensors 130.

Referring to FIGS. 12 and 13, the controller 110 may operate the drain valve 408, the cap control valve 430, the rod control valve 440, and the restriction valve 460 to reconfigure the stability cylinder 90 between the open configuration, the restricted configuration, and the closed configuration. Throughout all three configurations, the controller may activate the drain solenoid 410 to hold the drain valve 408 closed. If at any point the stability circuit 400 requires additional make up fluid (e.g., due to leakage or draining of fluid to another portion of the telehandler 10), the pump 34 may introduce additional fluid to the pressure supply node 404 through the supply valve 406.

To configure the stability cylinder 90 into the open configuration (e.g., in step 302), the controller 110 may control the solenoids of the cap control valve 430, the rod control valve 440, and the restriction valve 460 to move the cap control valve 430, the rod control valve 440, and the restriction valve 460 into the respective open positions. In the open configuration, when the stability cylinder 90 is retracted (e.g., the rod of the stability cylinder 90 moves to the left as shown in FIG. 13), fluid is forced out of the cap end of the stability cylinder 90 and into the stability circuit 400 through the cap end port 420. The fluid travels along a flow path (i) through the cap control valve 430, (ii) through the check valve 450, (iii) through the restriction valve 460, (iv) through the check valve 472, (v) through the rod control valve 440, and (vi) into the rod side of the stability cylinder 90 through the rod end port 422. Because the restriction valve 460 is in the open position, the restriction valve 460 minimally restricts the flow of the fluid.

In the open configuration, when the stability cylinder 90 is extended (e.g., the rod of the stability cylinder 90 moves to the right as shown in FIG. 13), fluid is forced out of the rod end of the stability cylinder 90 and into the stability circuit 400 through the rod end port 422. The fluid travels along a flow path (i) through the rod control valve 440, (ii) through the check valve 452, (iii) through the restriction valve 460, (iv) through the check valve 470, (v) through the cap control valve 430, and (vi) into the cap side of the stability cylinder 90 through the cap end port 420. Because the restriction valve 460 is in the open position, the restriction valve 460 minimally restricts the flow of the fluid. Due to the arrangement of the check valves 450, 452, 470, and 472, the fluid flows through the restriction valve 460 in the same direction during both extension and retraction of the stability cylinder 90.

Operation of the stability circuit 400 in the restricted configuration (e.g., in step 330) may be similar to operation in the open configuration, but the restriction valve 460 may be partially closed. The partial closure of the restriction valve 460 may cause the restriction valve 460 to act as an orifice, restricting flow between the chambers of the stability cylinder 90. This flow restriction introduces a damping force onto the stability cylinder 90, which in turn applies a damping force onto the rear axle assembly 80. The controller 110 may vary the magnitude of the damping force by varying the signal (e.g., current or voltage) applied to the restriction solenoid 462. Because the restriction valve 460 is a proportional valve, this change in signal partially opens or closes the restriction valve 460. In some embodiments, the controller 110 uses feedback from the pressure sensors 130 to determine how to adjust the restriction solenoid 462. While in the restricted configuration, if the pressure at the node 454 exceeds the threshold pressure of the relief valve 474, the relief valve 474 may open and permit fluid to bypass the restriction valve 460.

To configure the stability cylinder 90 into the locked configuration (e.g., in step 314), the controller 110 may control the solenoids of the cap control valve 430, the rod control valve 440, and the restriction valve 460 to move the cap control valve 430, the rod control valve 440, and the restriction valve 460 into the respective closed positions. In the closed configuration, when a force attempts to retract the stability cylinder 90, fluid is forced out of the cap end of the stability cylinder 90 and into the stability circuit 400 through the cap end port 420. The fluid reaches the cap control valve 430 in the closed position, which blocks the flow of fluid into the stability circuit 400 and holds the stability cylinder 90 in position. If the cap control valve 430 were to permit fluid flow to the node 432 (e.g., due to a component failure of the cap control valve 430), the fluid would pass through the check valve 450 to the restriction valve 460. The restriction valve 460 in the closed position would block fluid flow to the rod chamber of the stability cylinder 90. Accordingly, the restriction valve 460 advantageously acts redundantly to ensure continued functionality of the locked configuration in the event of a component failure.

If the pressure at the cap control valve 430 exceeds a threshold pressure of the relief valve 424, the relief valve 424 may permit the fluid to move to the pressure supply node 404. Accordingly, the relief valve 424 may prevent damage to the stability circuit 400 from an abnormally large pressure at the cap end port 420 (e.g., a pressure spike).

In the closed configuration, when a force attempts to extend the stability cylinder 90, fluid is forced out of the rod end of the stability cylinder 90 and into the stability circuit 400 through the rod end port 422. The fluid reaches the rod control valve 440 in the closed position, which blocks the flow of fluid into the stability circuit 400 and holds the stability cylinder 90 in position. If the rod control valve 440 were to permit fluid flow to the node 442 (e.g., due to a component failure of the rod control valve 440), the fluid would pass through the check valve 452 to the restriction valve 460. The restriction valve 460 in the closed position would block fluid flow to the rod chamber of the stability cylinder 90. Accordingly, the restriction valve 460 advantageously acts redundantly to ensure continued functionality of the locked configuration in the event of a component failure.

Beneficially, the stability circuit 400 permits automatic, active control over the stability cylinder 90 by the controller 110. Compared to other telehandlers with stability cylinders that are manually controlled, the stability circuit 400 may react more quickly and more consistently to indications of elevated boom height and/or instability conditions. Additionally, the stability circuit 400 permits automatic switching to restricted configuration, which increases lateral stability at elevated boom positions. Because the stability circuit 400 is activated automatically, the increased lateral stability may be considered when testing the capabilities (e.g., load maps) of the telehandler 10.

Because manual stability systems may not be consistently activated by the operators, such manual stability systems may rely on other systems for increasing lateral stability. For example, a telehandler with a manual stability system may rely on the addition of counterweights to the frame to improve lateral stability. Such counterweights increase the overall weight of the telehandler, reducing energy efficiency, and adding production steps and material costs to manufacture the telehandler. The automatic, active control of the stability circuit 400 permits such counterweights to be omitted without negatively impacting the lateral stability of the telehandler 10.

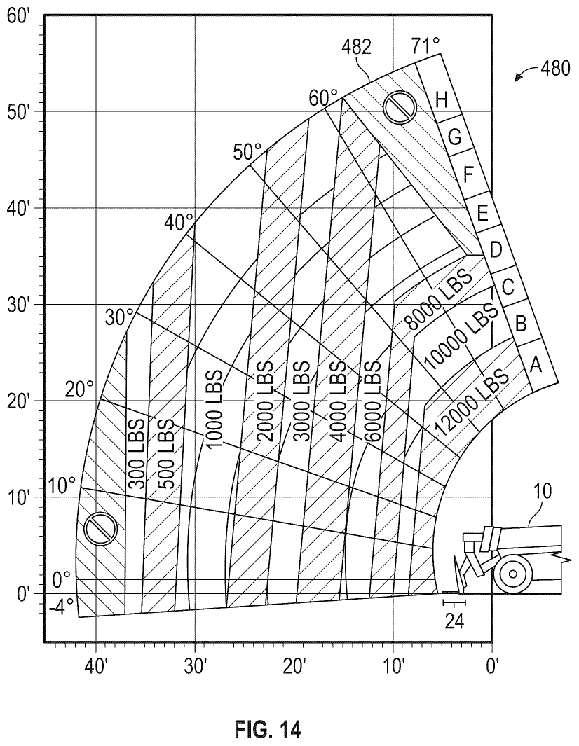

Referring to FIG. 14, a load chart 480 of a telehandler is shown according to an exemplary embodiment. The load chart 480 indicates allowable ranges of permitted locations for a boom assembly to manipulate a load based on a weight of the load. The load chart 480 includes a no-operation zone 482, within which the telehandler may be incapable of operating. In some embodiments, the restricted configuration of the stability cylinder 90 of the telehandler 10 increases the stability of the telehandler 10 while the boom assembly 50 is elevated. Accordingly, the restricted configuration may permit the telehandler 10 to operate within the no-operation zone 482 where other telehandler are not capable of operating.

### Partial Locking Configuration

Referring to FIGS. 13 and 15-18, the stability circuit 400 is reconfigurable into a half locked or partial locking configuration. In the partial locking configuration, the stability circuit 400 prevents rotation of the rear axle 82 in a first direction and permits rotation of the rear axle 82 in an opposing second direction (e.g., with or without restriction). Beneficially, the partial locking configuration may permit frame leveling in an uphill direction (i.e., rotation of the rear axle 82 in the second direction) while permitting four-point stability for loads that would otherwise cause rotation in the downhill direction (i.e., rotation of the rear axle 82 in the second direction.

The stability circuit 400 may be operable in two different partial locking configurations to exchange the directions where rotation is permitted or prevented. It may be desirable to permit the frame assembly 12 to roll in the first direction or the second direction depending upon the orientation of the telehandler 10. By way of example, the telehandler 10 may be operated on a slope, such that the left side of the telehandler 10 is oriented uphill. In such a configuration, it may be desirable to prevent motion that would move the telehandler 10 downhill (e.g., rolling the frame assembly 12 toward the right side), which could potentially have a negative impact on stability. It may be desirable to permit motion that would move the telehandler 10 uphill (e.g., rolling the frame assembly 12 toward the left side), as this motion may facilitate leveling the frame without negatively impacting stability. If the orientation of the telehandler 10 on the slope were inverted (e.g., such that the right side of the telehandler 10 is oriented uphill), it may be desirable to switch to the other partial locking configuration.

To configure the stability circuit 400 into the partial locking configurations, the controller 110 may configure one of the cap control valve 430 and the rod control valve 440 in the open position and the other of the cap control valve 430 and the rod control valve 440 in the closed position. The restriction valve 460 may be open to permit free movement or partially closed to restrict movement. The decision regarding whether to restrict the flow with the restriction valve 460 may be made according to the method 300.

In a first partial locking configuration, the cap control valve 430 is open and the rod control valve 440 is closed. When stability cylinder 90 is forced to retract, fluid exits the stability cylinder 90 through the cap end port 420. The fluid passes freely through the cap control valve 430 in the open position and passes through the check valve 450, the restriction valve 460, the check valve 472, and the check valve of the rod control valve 440, finally entering the stability cylinder 90 through the rod end port 422. Accordingly, the rear axle 82 is permitted to rotate in a first direction associated with retracting the stability cylinder 90. If a force is applied that attempts to extend the stability cylinder 90, fluid attempts to exit through the rod end port 422 but is stopped by the check valve of the rod control valve 440. Accordingly, the rear axle 82 is prevented from rotating in a second direction associated with extending the stability cylinder.

In a second partial locking configuration, the cap control valve 430 is closed and the rod control valve 440 is open. When stability cylinder 90 is forced to extend, fluid exits the stability cylinder 90 through the rod end port 422. The fluid passes freely through the rod control valve 440 in the open position and passes through the check valve 452, the restriction valve 460, the check valve 470, and the check valve of the cap control valve 430, finally entering the stability cylinder 90 through the cap end port 420. Accordingly, the rear axle 82 is permitted to rotate in the second direction. If a force is applied that attempts to retract the stability cylinder 90, fluid attempts to exit through the cap end port 420 but is stopped by the check valve of the cap control valve 430. Accordingly, the rear axle 82 is prevented from rotating in the first direction.

The controller 110 may control the stability circuit 400 to enter the partial locking configurations automatically and/or in response to a manual input. In some embodiments, the partial locking configurations take the place of the locked configuration in the method 300. In some embodiments, the controller 110 selects between the partial locking configurations based on the current roll angle of the frame assembly 12 (e.g., as measured using the roll angle sensor 142). In some embodiments, the controller 110 controls the stability circuit 400 to enter one of the partial locking configurations in response to a manual input selecting the partial locking configuration (e.g., through the user interface 120).

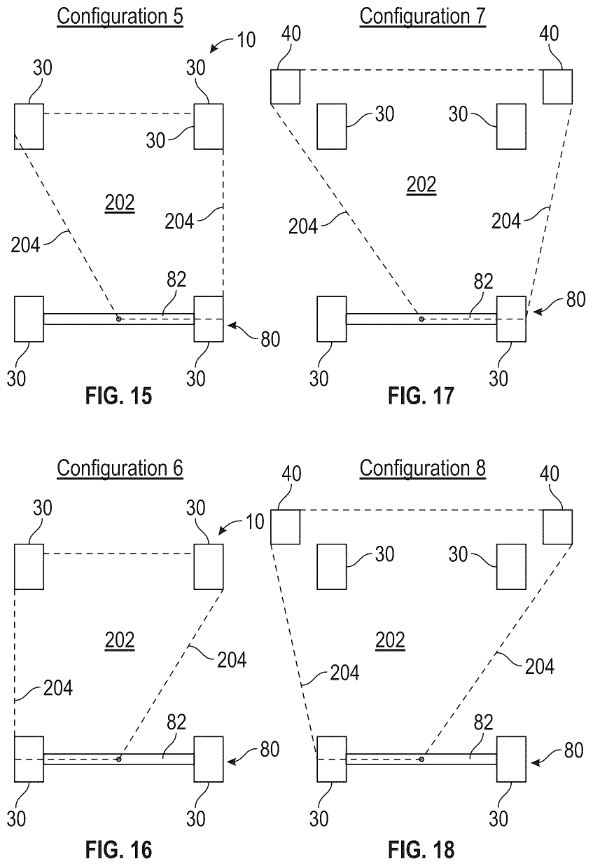

Referring to FIGS. 15-18, stability maps for each of the partial locking configurations are shown. Similar to the stability maps illustrating four configurations of the telehandler 10 in FIGS. 6-9, each stability map shows a range of stable locations 202 bounded by a pair of tip lines 204. In a fifth configuration shown in FIG. 15 and a sixth configuration shown in FIG. 16, the outriggers 40 are retracted (e.g., not deployed). In each of the fifth and sixth configurations, (a) a first tip line 204 extends between a front wheel and the axis of rotation of the rear axle assembly 80 and (b) a second tip line 204 extends between the other front wheel and a rear wheel of the rear axle assembly 80. The fifth configuration represents a first partial locking configuration in which the range of stable locations 202 extends to the right, and the sixth configuration represents a second partial locking configuration in which the range of stable locations 202 extends to the left.

In a seventh configuration shown in FIG. 17 and an eighth configuration shown in FIG. 18, the outriggers 40 are deployed. In each of the seventh and eighth configurations, (a) a first tip line 204 extends between an outrigger 40 and the axis of rotation of the rear axle assembly 80 and (b) a second tip line 204 extends between the other outrigger 40 and a rear wheel of the rear axle assembly 80. The seventh configuration represents a first partial locking configuration in which the range of stable locations 202 extends to the right, and the eighth configuration represents a second partial locking configuration in which the range of stable locations 202 extends to the left.

### Alternative Hydraulic Arrangements

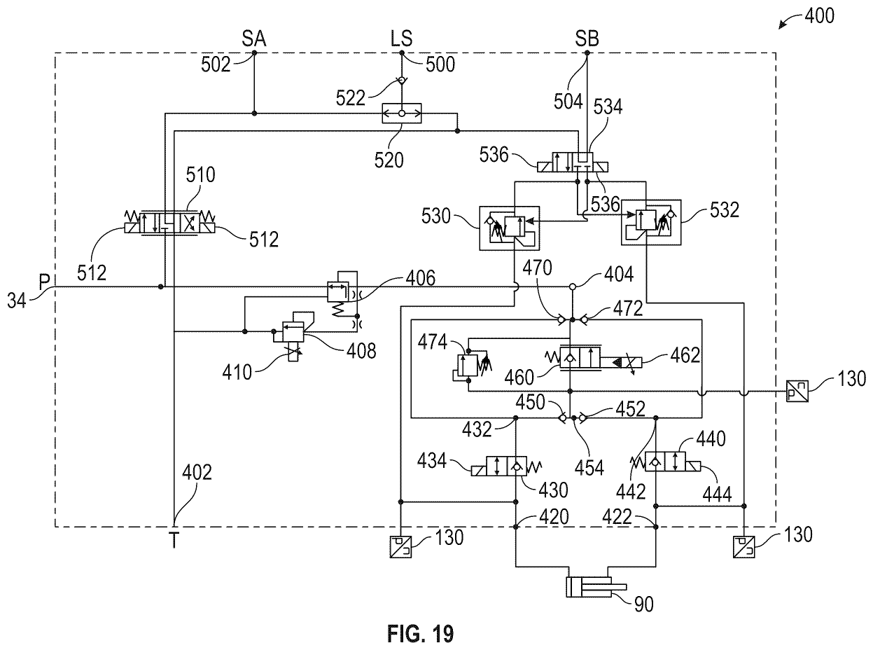

Referring to FIG. 19, the stability circuit 400 is shown according to an alternative embodiment. The stability circuit 400 of FIG. 19 may be substantially similar to the stability circuit 400 of FIG. 13, except as otherwise specified herein. The stability circuit 400 of FIG. 19 includes additional load sensing and sway cylinder features that interact with the stability circuit 400.

The stability circuit 400 is fluidly coupled to a load sensing port, shown as load sense port 500. In some embodiments, the pump 34 is a load sensing pump that utilizes pressure feedback from the stability circuit 400 to vary operation of the pump 34. The load sense port 500 may provide a pressure feedback signal to the pump 34. The stability circuit 400 is further fluidly coupled to a secondary hydraulic actuator of the telehandler 10, shown as a sway cylinder. The sway cylinder may control movement of a portion of the telehandler 10. The sway cylinder includes a first chamber, shown as bore chamber 502, and a second chamber, shown as rod chamber 504. Supplying fluid to the bore chamber 502 may extend the sway cylinder. Supplying fluid to the rod chamber 504 may retract the sway cylinder.

The pump 34 and the tank 402 are fluidly coupled to the bore chamber 502 through a three-position, proportional directional control valve, shown as directional control valve 510. The directional control valve 510 includes a pair of solenoids 512 that control operation of the directional control valve 510. The directional control valve 510 may be operated by the controller 110.

The stability circuit 400 further includes a shuttle valve 520 having an output that is fluidly coupled to the load sense port 500 through a check valve 522. The shuttle valve 520 has a pair of inputs, and the shuttle valve 520 fluidly couples the output to whichever of the inputs has a higher pressure. The first input of the shuttle valve 520 is fluidly coupled to the directional control valve 510 and the bore chamber 502.

A first flow control element, shown as counterbalance valve 530, is fluidly coupled to the cap end port 420. A second flow control element, shown as counterbalance valve 532, is fluidly coupled to the rod end port 422. The counterbalance valves 530 and 532 are each fluidly coupled to a directional control valve 534. The directional control valve 534 includes a pair of solenoids 536 that control operation of the directional control valve 534. The directional control valve 534 may be operated by the controller 110. In a first position, the directional control valve 534 fluidly couples the rod chamber 504 to the second input of the shuttle valve 520. In a second position, the directional control valve 534 (a) fluidly couples an output of the counterbalance valve 530 to the second input of the shuttle valve 520 and (b) fluidly couples an output of the counterbalance valve 532 to the rod chamber 504.

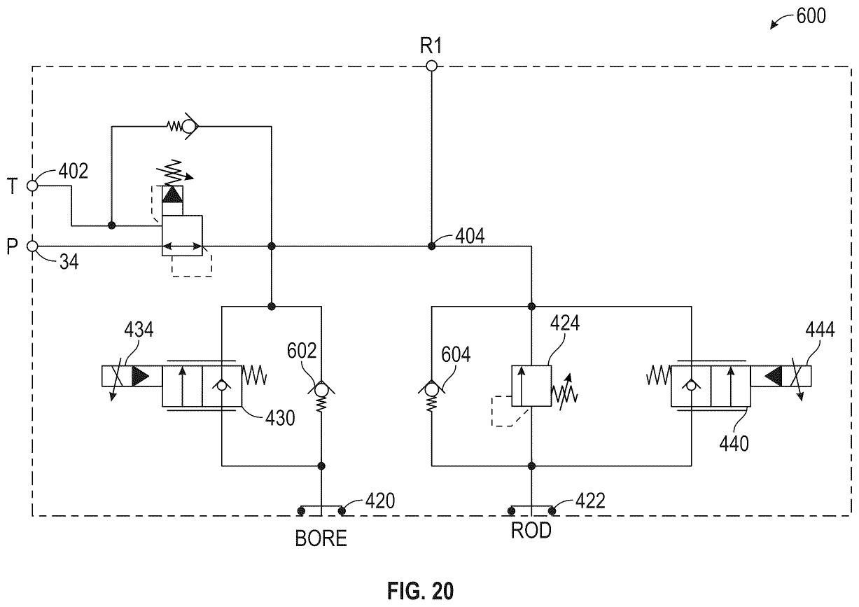

Referring to FIG. 20, a stability circuit 600 is shown according to an exemplary embodiment. The stability circuit 600 of FIG. 20 may be substantially similar to the stability circuit 400 of FIG. 13, except as otherwise specified herein. The stability circuit 600 of FIG. 20 omits the restriction valve 460. Accordingly, the cap control valve 430 and the rod control valve 440 are in direct fluid communication with the pressure supply node 404.

As shown, the cap control valve 430 is configured as proportional directional control valve that is continuously adjustable using the cap solenoid 434. The cap control valve 430 is arranged in parallel with a flow control element, shown as check valve 602, that is fluidly coupled to the cap end port 420 and the pressure supply node 404. The check valve 602 permits fluid flow from the pressure supply node 404 to the cap end port 420 through the check valve 602. The check valve 602 prevents fluid flow from the cap end port 420 to the pressure supply node 404 through the check valve 602.

As shown, the rod control valve 440 is configured as proportional directional control valve that is continuously adjustable using the rod solenoid 444. The rod control valve 440 is arranged in parallel with a flow control element, shown as check valve 604, that is fluidly coupled to the rod end port 422 and the pressure supply node 404. The check valve 604 permits fluid flow from the pressure supply node 404 to the rod end port 422 through the check valve 604. The check valve 604 prevents fluid flow from the rod end port 422 to the pressure supply node 404 through the check valve 604. The rod control valve 440 and the relief valve 424 are arranged in parallel with one another.

When the cap control valve 430 is in the closed position, the cap control valve 430 and the check valve 602 prevent fluid flow from the cap end port 420 to the pressure supply node 404 and permit fluid flow from the pressure supply node 404 to the cap end port 420. When the cap control valve 430 is in the open position, the cap control valve 430 permits fluid flow from the cap end port 420 to the pressure supply node 404. By moving the cap control valve 430 to a position between the open position and the closed position, the cap control valve 430 may act as a variable orifice that variably resists fluid flow from the cap end port 420 to the pressure supply node 404.

When the rod control valve 440 is in the closed position, the rod control valve 440 and the check valve 604 prevent fluid flow from the rod end port 422 to the pressure supply node 404 and permit fluid flow from the pressure supply node 404 to the rod end port 422. If the pressure at the rod end port 422 is sufficient to actuate the relief valve 424, the relief valve 424 permits fluid flow from the rod end port rod end port 422 to the pressure supply node 404, bypassing the rod control valve 440 and the check valve 604. When the rod control valve 440 is in the open position, the rod control valve 440 permits fluid flow from the rod end port 422 to the pressure supply node 404. By moving the rod control valve 440 to a position between the open position and the closed position, the rod control valve 440 may act as a variable orifice that variably resists fluid flow from the rod end port 422 to the pressure supply node 404.

The stability circuit 600 may be operable in an open configuration, a restricted configuration, a locked configuration, and a pair of partial locking configurations. To configure the stability circuit 600 in the open configuration, both the cap control valve 430 and the rod control valve 440 may be moved to the open positions. To configure the stability circuit 600 in the locked configuration, both the cap control valve 430 and the rod control valve 440 may be moved to the closed positions. To configure the stability circuit 600 in the restricted configuration, the cap control valve 430 and/or the rod control valve 440 may be moved to positions between the open position and the closed position. The position of the cap control valve 430 may govern the rate at which the stability cylinder 90 retracts, and the position of the rod control valve 440 may govern the rate at which the stability cylinder 90 extends. To configure the stability circuit 600 in a first partial locking configuration, the cap control valve 430 may be in the open position or a partially open position, and the rod control valve 440 may be in the closed position. To configure the stability circuit 600 in a second partial locking configuration, the rod control valve 440 may be in the open position or a partially open position, and the cap control valve 430 may be in the closed position.

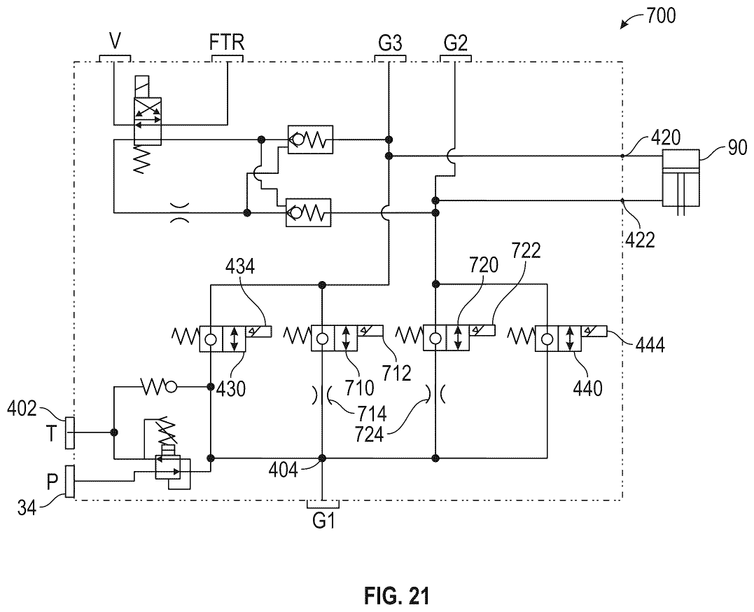

Referring to FIG. 21, a stability circuit 700 is shown according to an exemplary embodiment. The stability circuit 700 of FIG. 21 may be substantially similar to the stability circuit 400 of FIG. 13, except as otherwise specified herein. The stability circuit 700 of FIG. 21 omits the restriction valve 460. Accordingly, the cap control valve 430 and the rod control valve 440 are in direct fluid communication with the pressure supply node 404.

The stability circuit 700 further includes a directional control valve, shown as restricted cap control valve 710. The restricted cap control valve 710 is repositionable between an open position and a closed position by an actuator, shown as cap solenoid 712. The controller 110 may control the cap solenoid 712 to reposition the restricted cap control valve 710. A flow restriction, shown as orifice 714, is in fluid communication with the restricted cap control valve 710. Specifically, the restricted cap control valve 710 and the orifice 714 together are arranged in parallel with the cap control valve 430, such that the cap end port 420 is selectively in fluid communication with the pressure supply node 404 through the restricted cap control valve 710 and the orifice 714. Similar to the cap control valve 430, the restricted cap control valve 710 includes a check valve that permits fluid flow from the pressure supply node 404 to the cap end port 420 through the restricted cap control valve 710 when the restricted cap control valve 710 is in the closed position. The orifice 714 restricts flow through the restricted cap control valve 710, such that fluid flows more readily through the cap control valve 430 than the restricted cap control valve 710.

The stability circuit 700 further includes a directional control valve, shown as restricted rod control valve 720. The restricted rod control valve 720 is repositionable between an open position and a closed position by an actuator, shown as rod solenoid 722. The controller 110 may control the rod solenoid 722 to reposition the restricted rod control valve 720. A flow restriction, shown as orifice 724, is in fluid communication with the restricted rod control valve 720. Specifically, the restricted rod control valve 720 and the orifice 724 together are arranged in parallel with the rod control valve 440, such that the rod end port 422 is selectively in fluid communication with the pressure supply node 404 through the restricted rod control valve 720 and the orifice 724. Similar to the rod control valve 440, the restricted rod control valve 720 includes a check valve that permits fluid flow from the pressure supply node 404 to the rod end port 422 through the restricted rod control valve 720 when the restricted rod control valve 720 is in the closed position. The orifice 724 restricts flow through the restricted rod control valve 720, such that fluid flows more readily through the rod control valve 440 than the restricted rod control valve 720.

The stability circuit 700 may be operable in an open configuration, a restricted configuration, a locked configuration, and a pair of partial locking configurations. To configure the stability circuit 700 in the open configuration, both the cap control valve 430 and the rod control valve 440 may be moved to the open positions. The restricted cap control valve 710 and the restricted rod control valve 720 may be in the open position or the closed position in the open configuration. To configure the stability circuit 700 in the locked configuration, all of the cap control valve 430, the rod control valve 440, the restricted cap control valve 710, and the restricted rod control valve 720 may be moved to the closed positions.

To configure the stability circuit 700 in the restricted configuration, the cap control valve 430 and/or the rod control valve 440 may be in the closed positions, and the restricted cap control valve 710 and/or the restricted rod control valve 720 may be in the open positions. When attempting to retract the stability cylinder 90, the cap control valve 430 is in the closed position and the restricted cap control valve 710 is in the open position, such that restricted flow is permitted through the orifice 714. When attempting to extend the stability cylinder 90, the rod control valve 440 is in the closed position and the restricted rod control valve 720 is in the open position, such that restricted flow is permitted through the orifice 724.

To configure the stability circuit 700 in a first partial locking configuration, the cap control valve 430 and/or the restricted cap control valve 710 may be the open positions, and the rod control valve 440 and the restricted rod control valve 720 may be in the closed positions. To configure the stability circuit 700 in a second partial locking configuration, the rod control valve 440 and/or the restricted rod control valve 720 may be in the open positions, and the cap control valve 430 and the restricted cap control valve 710 may be in the closed positions.

As utilized herein with respect to numerical ranges, the terms “approximately,” “about,” “substantially,” and similar terms generally mean +/-10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the telehandler 10 as shown in the various exemplary embodiments is illustrative only. Additionally, any element disclosed in one embodiment may be incorporated or utilized with any other embodiment disclosed herein. For example, the stability circuit 400 of the exemplary embodiment shown in at least FIG. 19, the stability circuit 600 of the exemplary embodiment shown in at least FIG. 20, and the stability circuit 700 of the exemplary embodiment shown in at least FIG. 21, may each be incorporated in the telehandler 10 of the exemplary embodiment shown in at least FIG. 1. Although only a few examples elements from one embodiment that can be incorporated or utilized in another embodiment has been described above, it should be appreciated that other elements of the various embodiments may be incorporated or utilized with any of the other embodiments disclosed herein.

What is claimed is:

1. A telehandler, comprising:
a chassis;
an axle pivotably coupled to the chassis;
a tractive element rotatably coupled to the axle;
a stability cylinder coupled to the axle and the chassis;
a boom assembly coupled to the chassis;
an actuator configured to move at least a portion of the boom assembly relative to the chassis;
a roll angle sensor coupled to the chassis and configured to provide first sensor data indicating a roll angle of the chassis;
a boom angle sensor configured to provide second sensor data indicating a boom angle between the boom assembly and the chassis; and
a controller operatively coupled to the roll angle sensor and the boom angle sensor, wherein the controller is configured to control the stability cylinder to limit movement of the axle relative to the chassis based on the first sensor data and the second sensor data.

2. The telehandler of claim 1, wherein the controller is configured to:
determine whether the roll angle of the chassis exceeds a threshold roll angle;
determine whether the boom angle exceeds a threshold boom angle; and
control the stability cylinder to limit the movement of the axle relative to the chassis in response to a determination that the roll angle of the chassis exceeds the threshold roll angle while the boom angle exceeds the threshold boom angle.

3. The telehandler of claim 2, wherein the stability cylinder is reconfigurable between (a) an unlocked configuration in which the stability cylinder permits movement of the axle relative to the chassis and (b) a locked configuration in which the stability cylinder prevents movement of the axle relative to the chassis; and
reconfigure the stability cylinder from the unlocked configuration to the locked configuration in response to the determination that the roll angle of the chassis exceeds the threshold roll angle while the boom angle is above the threshold boom angle.

4. The telehandler of claim 3, wherein the controller is configured to reconfigure the stability cylinder from the locked configuration into the unlocked configuration in response to a determination that the boom angle is below the threshold boom angle.

5. The telehandler of claim 3, wherein the stability cylinder is reconfigurable into a restricted configuration in which the stability cylinder applies a dampening force that resists the movement of the axle relative to the chassis.

6. The telehandler of claim 5, wherein the controller is configured to reconfigure the stability cylinder into the restricted configuration in response to a determination that the roll angle of the chassis does not exceed the threshold roll angle while the boom angle is above the threshold boom angle.

7. The telehandler of claim 1, wherein the stability cylinder is reconfigurable into a partial locking configuration in which the stability cylinder permits movement of the axle relative to the chassis in a first direction and prevents movement of the axle relative to the chassis in a second direction.

8. The telehandler of claim 1, further comprising a driver coupled to the chassis and configured to propel the telehandler, wherein the controller is configured to:
determine whether the roll angle of the chassis exceeds a threshold roll angle while the boom angle is above a threshold boom angle; and
in response to a determination that the roll angle of the chassis exceeds the threshold roll angle while the boom angle is above the threshold boom angle, at least one of (a) activate an alarm, (b) limit operation of the actuator, or (c) limit operation of the driver.

9. A lift device, comprising:
a chassis;
a tractive element coupled to the chassis;
a driver coupled to the chassis and configured to drive the tractive element to propel the lift device;
a boom assembly coupled to the chassis;
an actuator configured to move at least a portion of the boom assembly relative to the chassis;
a roll angle sensor coupled to the chassis and configured to provide sensor data indicating a roll angle of the chassis;
a boom angle sensor configured to measure a boom angle between the boom assembly and the chassis; and
a controller operatively coupled to the roll angle sensor and the boom angle sensor, wherein the controller is configured to:
determine whether the roll angle of the chassis exceeds a threshold roll angle;
determine whether the boom angle exceeds a threshold boom angle; and
in response to a determination that the roll angle of the chassis exceeds the threshold roll angle while the boom angle exceeds the threshold boom angle, at least one of (a) activate an alarm, (b) limit operation of the actuator, or (c) limit operation of the driver.

10. The lift device of claim 9, wherein the controller is configured to activate the alarm in response to the determination that the roll angle of the chassis exceeds the threshold roll angle while the boom angle is above the threshold boom angle, the alarm including at least one of an audible notification or a visual notification.

11. The lift device of claim 9, wherein the controller is configured to limit the operation of the actuator in response to the determination that the roll angle of the chassis exceeds the threshold roll angle while the boom angle is above the threshold boom angle.

12. The lift device of claim 11, wherein the controller is configured to reduce a speed of the actuator in response to the determination that the roll angle of the chassis exceeds the threshold roll angle while the boom angle is above the threshold boom angle.

13. The lift device of claim 11, wherein the controller is configured to prevent movement of the actuator in a first direction while permitting movement of the actuator in a second direction opposite the first direction in response to the determination that the roll angle of the chassis exceeds the threshold roll angle while the boom angle is above the threshold boom angle.

14. The lift device of claim 11, wherein the boom assembly includes a first boom section pivotably coupled to the chassis and a second boom section slidably coupled to the first boom section, and wherein the actuator is one of (a) a lift actuator configured to raise the first boom section relative to the chassis or (b) an extension actuator configured to extend the second boom section relative to the first boom section.

15. The lift device of claim 9, wherein the controller is configured to limit the operation of the driver in response to the determination that the roll angle of the chassis exceeds the threshold roll angle while the boom angle is above the threshold boom angle.

16. The lift device of claim 15, wherein the driver is configured to drive the tractive element to propel the lift device at a travel speed, and wherein the controller is configured to limit the travel speed of the lift device in response to the determination that the roll angle of the chassis exceeds the threshold roll angle while the boom angle is above the threshold boom angle.

17. A telehandler, comprising:
a chassis;
an axle pivotably coupled to the chassis;
a tractive element rotatably coupled to the axle;
a stability cylinder coupled to the axle and the chassis, the stability cylinder having a first chamber and a second chamber;
a boom assembly coupled to the chassis;
an actuator configured to move at least a portion of the boom assembly relative to the chassis; and
a valve assembly fluidly coupled to the first chamber and the second chamber, the valve assembly including a first valve and a second valve,
wherein in an open configuration of the valve assembly, a flow path is defined from the first chamber, through the first valve, through the second valve, and to the second chamber; and
wherein in a locked configuration of the valve assembly, the first valve fluidly decouples the first chamber from the second chamber, such that the stability cylinder limits movement of the axle relative to the chassis.

18. The telehandler of claim 17, wherein in the locked configuration of the valve assembly, the first valve fluidly decouples the first chamber from the second valve.

19. The telehandler of claim 17, wherein the second valve is a proportional valve, and wherein in a restricted configuration of the valve assembly, the proportional valve is configured to partially close to permit restricted flow along the flow path.

20. The telehandler of claim 17, wherein the valve assembly further includes a third valve;
wherein in the open configuration of the valve assembly, the flow path is defined from the first chamber, through the first valve, through the second valve, through the third valve, and to the second chamber;
wherein in the locked configuration of the valve assembly, the first valve and the third valve fluidly decouple the first chamber from the second chamber, such that the stability cylinder prevents movement of the axle relative to the chassis; and
wherein in a partial locking configuration of the valve assembly, the first valve fluidly couples the first chamber to the second chamber through a check valve that permits flow into the first chamber but prevents flow out of the first chamber.
